(19) United States
(12) Patent Application Publication
(10) Pub. No.: US 2026/0289884 A1
(43) Pub. Date: Sep. 24, 2026

(54) SYSTEM

(71) Applicant: SoftBank Group Corp., Tokyo (JP)

(72) Inventor: Yuki ICHIOKA, Tokyo (JP)

(73) Assignee: SoftBank Group Corp., Tokyo (JP)

(21) Appl. No.: 19/567,340

(22) Filed: Mar. 16, 2026

(30) Foreign Application Priority Data
Mar. 19, 2025 (JP) 2025-044978

(51) Int. Cl. G06T 13/20; G06T 13/40; G10L 15/16; G10L 15/18; G10L 15/22; G10L 21/10

(52) U.S. Cl. CPC G06T 13/205; G06T 13/40; G10L 15/16; G10L 15/1822; G10L 15/22; G10L 21/10; G10L 2015/223

(57) ABSTRACT

A system includes a processor that is configured to analyze a prompt sentence received from a user and generate feature data by using a prompt that instructs determination of an appearance and a personality of an avatar, transmit the generated feature data to a terminal of the user so as to cause the avatar to be visually displayed on the terminal, and estimate an emotional state of the user and analyze a prompt for generating a reaction of the avatar.

### CROSS-REFERENCE TO RELATED APPLICATION

This application is based on and claims priority under 35 USC 119 from Japanese Patent Application No. 2025-044978 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Modern users, including elderly individuals, people living alone, and users experiencing social isolation, often suffer from a sense of loneliness and psychological stress due to limited opportunities for daily interpersonal interaction. Conventional avatar systems and virtual agents generally provide only static or pre-scripted responses, and are not sufficiently capable of adapting an avatar's appearance, personality, and reaction to a user's preferences and emotional state in real time. In particular, known systems do not adequately analyze user-provided prompt sentences to flexibly determine the avatar's visual characteristics and personality traits, nor do they sufficiently estimate the user's emotional state and modify the avatar's reaction in a manner that provides continuous and personalized emotional support. Therefore, there is a need for a system that can dynamically generate feature data for an avatar based on user prompts, visually present the avatar on a user terminal, and adapt the avatar's reactions according to the user's emotional state so as to reduce the user's sense of loneliness through natural interaction.

### SUMMARY

To solve the above-described problems, according to one aspect of the present invention, there is provided a system comprising a processor, wherein the processor is configured to analyze a prompt sentence received from a user and generate feature data by using a prompt that instructs determination of an appearance and a personality of an avatar, transmit the generated feature data to a terminal of the user so as to cause the avatar to be visually displayed on the terminal, and estimate an emotional state of the user and analyze a prompt for generating a reaction of the avatar. In one embodiment, the processor is configured to analyze the prompt sentence by using natural language processing and thereby understand a prompt that instructs changing the appearance or the personality of the avatar, so that the avatar can be flexibly customized in accordance with the user's changing preferences. In another embodiment, the processor is configured to generate a reaction of the avatar corresponding to the emotional state of the user and alleviate a sense of loneliness of the user through interaction between the user and the avatar. By such configuration, the system can provide an avatar that is visually and behaviorally adapted to the user and that responds in an emotionally appropriate manner, thereby supporting the user's daily life and mitigating feelings of loneliness.

The term “system” refers to an overall arrangement including at least one processor and one or more terminals, together with memories, communication interfaces, and software modules that cooperate to perform the functions described in the claims.

The term “processor” refers to any hardware component or combination of components that executes instructions, including but not limited to a central processing unit (CPU), a microprocessor, a microcontroller, a digital signal processor (DSP), a graphics processing unit (GPU), or a programmable logic device configured to perform the claimed processing.

The term “prompt sentence” refers to a sentence or text input provided by the user, in natural language or a similar expressive form, that contains instructions, requests, or information to be analyzed by the processor for determining avatar-related operations.

The term “prompt” refers to information, including text or structured data derived from a prompt sentence, that indicates or instructs specific processing to be performed by the processor, such as determining, changing, or generating an appearance, personality, or reaction of an avatar.

The term “feature data” refers to data representing one or more characteristics of an avatar, including parameters defining appearance, personality traits, behavior patterns, or other attributes used for visual display or behavioral control of the avatar on the terminal.

The term “appearance” refers to visual characteristics of the avatar, including but not limited to shape, form, color, size, clothing, facial features, and other graphic elements that define how the avatar is visually represented on the terminal.

The term “personality” refers to behavioral and attitudinal characteristics assigned to the avatar, including traits such as talkativeness, cheerfulness, calmness, or formality, which influence the style and manner of the avatar's reactions and interactions with the user.

The term “avatar” refers to a virtual character or agent, represented visually and optionally audibly on the terminal, whose appearance, personality, and reactions are controlled or influenced by the processor based on user input and the user's emotional state.

The term “terminal” refers to any user device capable of communication with the system, including but not limited to a smartphone, tablet, personal computer, smart display, or other electronic apparatus that can receive feature data and visually display the avatar.

The term “visually displayed” refers to the presentation of the avatar on a screen or other visual output interface of the terminal, including two-dimensional or three-dimensional rendering, animation, or graphical indication sufficient for the user to recognize and interact with the avatar.

The term “emotional state” refers to a psychological condition of the user, such as happiness, sadness, anxiety, excitement, calmness, or loneliness, estimated by the processor based on user input or other detectable cues.

The term “reaction of the avatar” refers to an output generated by the processor for presentation by the avatar, including text, speech, gestures, facial expressions, animations, or other behaviors, which are selected or modified in accordance with the user's emotional state or prompt.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

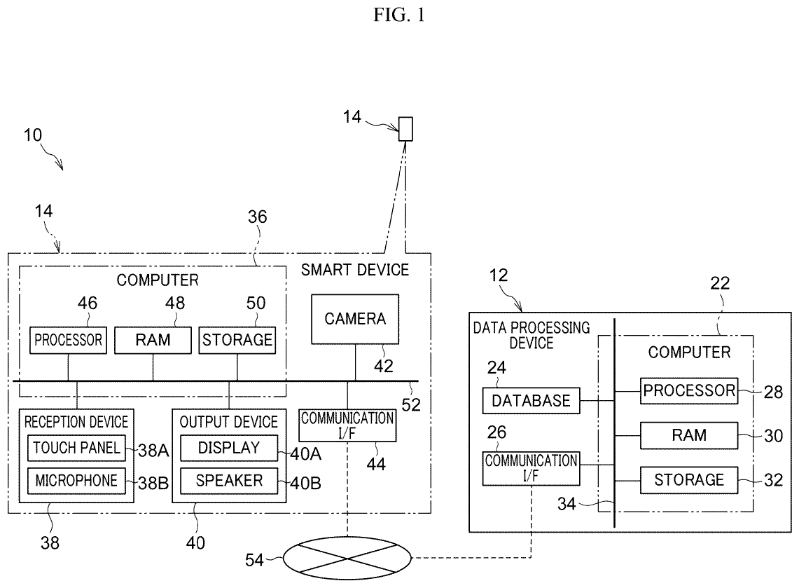

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

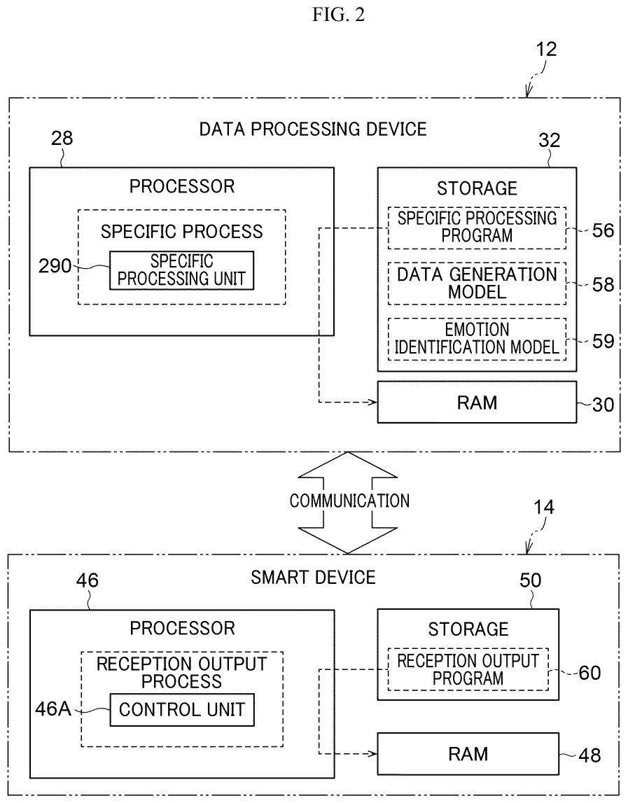

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional avatar interaction systems typically employ fixed rule-based engines or statically configured templates to determine avatar appearance and conversational behavior. In such systems, user input is mapped to pre-defined categories through simple keyword matching or shallow natural language processing, and avatar responses are generated from limited script sets. As a result, these systems suffer from several technical drawbacks.

First, the systems lack a robust mechanism for converting unstructured natural language prompt sentences from a user terminal into machine-readable, fine-grained avatar control parameters. Because prompt understanding is not tightly integrated with a generative AI model, the mapping from input text to avatar traits such as appearance, personality, and behavior patterns is coarse and inflexible. This leads to poor utilization of computational resources on the server side, since repeated manual configuration or ad hoc rule expansion is required to cover diverse user preferences.

Second, existing architectures generally do not maintain a structured, parameterized avatar profile that is iteratively updated through multiple prompt sentences and dialogue turns. When a user inputs a new preference or customization request, many systems regenerate the avatar from scratch or apply simplistic overrides, causing inconsistencies between visual appearance, behavior patterns, and conversational style. This lack of dynamic, parameter-level adjustment impairs the ability of the computing system to maintain coherent state over time, which in turn degrades response relevance and user experience.

Third, the processing pipeline from user prompt input to avatar visual rendering and conversational response is often fragmented. Image generation, conversational response generation, and emotional state estimation are handled in isolation, without a unified prompt-engineering framework or structured data flow. Consequently, computational steps are duplicated, context is lost between modules, and the server cannot effectively adapt avatar reactions based on the user's evolving emotional state across multiple interactions. This fragmentation leads to inefficient use of the processor and memory resources and limits scalability for large numbers of concurrent users.

Fourth, many known systems do not leverage conversational history and inferred emotional states as structured inputs to a generative AI model in order to adapt the avatar's response style and reaction patterns on a per-user basis. Without systematic incorporation of dialogue history and emotional context into prompt sentences and feature data, the system cannot technically optimize the generative process for context-aware, personalized interactions. This results in generic responses that do not fully exploit the capabilities of advanced generative AI models and do not improve the technical quality of the interaction loop.

Accordingly, there is a need for an improved computer-implemented system that: (i) analyzes prompt sentences from a user terminal using natural language processing to extract structured attribute information; (ii) generates and maintains a machine-readable avatar profile comprising separate parameters for appearance, personality, and behavior patterns; (iii) orchestrates generative AI models for both avatar features and image data through well-defined prompt sentences; and (iv) updates avatar feature data and prompt sentences dynamically based on dialogue history and estimated user emotional states. Such a system should technically enhance the efficiency, adaptability, and coherence of avatar generation and interaction processes executed by a processor, thereby improving the overall functioning of the computer system itself.

The specific processing by the specific processing unit 290 of the data processing device 12 in Example 1 is realized by the following means.

The present invention provides a server comprising a processor configured to receive, from a user terminal, input information including a prompt sentence, analyze the prompt sentence by natural language processing to extract attribute information representing user preferences, generate, based on the attribute information and the prompt sentence, a further prompt sentence for instructing a generative AI model to determine appearance, personality, and behavior patterns of an avatar, execute the generative AI model on a computing device to generate structured data including feature data of the avatar, create, based on the structured data, an image-generation prompt sentence for generating a visual representation of the avatar, generate image data of the avatar by using a generative image model, transmit the feature data and the image data to the user terminal so that the avatar is visually displayable on the user terminal, receive, via the user terminal, a dialogue message transmitted from a user to the avatar, generate, based on the dialogue message and the feature data, a conversation-generation prompt sentence, generate a response message of the avatar by using the generative AI model, estimate an emotional state of the user based on contents of the dialogue message and the response message, and update at least a part of the feature data and the conversation-generation prompt sentence in accordance with the estimated emotional state so as to dynamically adjust reaction characteristics of the avatar for each dialogue. This enables the server to implement an integrated, stateful avatar control pipeline in which unstructured natural language inputs are converted into structured avatar parameters, generative AI models are orchestrated through machine-readable prompt sentences, and avatar traits and responses are iteratively adapted based on dialogue history and emotional state estimation, thereby improving computational efficiency, consistency of avatar behavior, and overall performance of the computer system in generating personalized, context-aware avatar interactions.

The term “user” refers to a human operator who interacts with the system via a user terminal and provides input information including prompt sentences and dialogue messages.

The term “user terminal” refers to an electronic device operated by the user, such as a portable information processing device or a general-purpose computing device, that is configured to transmit prompt sentences and dialogue messages to the server and to receive and display avatar-related data.

The term “server” refers to an information processing apparatus including at least one processor and a memory, configured to communicate with one or more user terminals over a communication network and to execute the processes described in the claims.

The term “processor” refers to a hardware computation unit, such as a central processing unit, a graphics processing unit, or a specialized accelerator, that executes instructions to realize the functions of receiving, analyzing, generating, and transmitting data as recited in the claims.

The term “prompt sentence” refers to a natural-language text string provided by the user or generated by the processor, which is used to instruct a generative AI model to perform a specific task, including but not limited to determining avatar attributes, generating images, or generating dialogue responses.

The term “input information” refers to data received from the user terminal, including at least the prompt sentence and optionally additional metadata such as user identification information, device information, or context information.

The term “attribute information” refers to structured information representing preferences or requirements of the user, derived from analysis of a prompt sentence, and including, for example, desired traits of avatar appearance, personality, and behavior patterns.

The term “natural language processing” refers to a set of computerized techniques for analyzing and processing human language text, including tokenization, part-of-speech tagging, parsing, semantic analysis, and entity extraction, to convert unstructured text into structured data.

The term “generative AI model” refers to a machine-learned model, such as a neural network-based generative model, configured to produce output data (including text, parameters, or other structured information) in response to an input prompt sentence.

The term “generative image model” refers to a generative AI model configured to generate image data representing at least a part of an avatar, based on an image-generation prompt sentence or other input data.

The term “avatar” refers to a virtual entity represented by data managed by the server, including at least appearance, personality, and behavior patterns, and presented visually and/or interactively on the user terminal.

The term “appearance” refers to visual attributes of an avatar, including but not limited to species, shape, color, style, facial expression, clothing, and other graphical characteristics.

The term “personality” refers to behavioral and psychological characteristics of an avatar, including but not limited to talkativeness, friendliness, energy level, calmness, and conversational tone, which influence how the avatar responds in interactions.

The term “behavior patterns” refers to predefined or learned patterns of actions, gestures, response styles, or topic preferences of an avatar that are used to control how the avatar behaves in response to user inputs.

The term “feature data” refers to structured data representing at least one attribute of the avatar, including appearance parameters, personality parameters, and behavior pattern parameters, which collectively define the avatar profile.

The term “structured data” refers to data organized according to a predefined schema or format, such as a set of key-value pairs, a parameter vector, or a hierarchical object, that is machine-readable and suitable for programmatic processing.

The term “avatar profile” refers to a collection of structured data, including feature data and optionally conversation configuration data, that defines the state and characteristics of an avatar managed by the server.

The term “image-generation prompt sentence” refers to a prompt sentence generated by the processor, based on the feature data or structured data, and provided to a generative image model to instruct the generation of avatar image data.

The term “image data” refers to digital data representing one or more images of the avatar, in a format suitable for storage, transmission, and display on the user terminal.

The term “dialogue message” refers to a text message transmitted from the user to the avatar or from the avatar to the user, as part of an interactive conversation session.

The term “response message” refers to a dialogue message generated by the processor using a generative AI model, representing a reply or reaction of the avatar to a dialogue message received from the user.

The term “conversation-generation prompt sentence” refers to a prompt sentence generated by the processor, based on at least a dialogue message and feature data, and provided to a generative AI model to instruct generation of a response message of the avatar.

The term “emotional state” refers to an inferred psychological condition of the user, such as happiness, sadness, loneliness, anxiety, or calmness, estimated by the processor based on analysis of dialogue messages and response messages.

The term “reaction characteristics” refers to parameters or rules determining how the avatar responds to user inputs, including response style, tone, timing, topic selection, and selection of behavior patterns, which can be adjusted dynamically.

The term “history information” refers to stored information representing a sequence of dialogue messages and response messages exchanged between the user terminal and the server over time.

The term “additional input” refers to data, including at least history information or emotional state information, provided to the generative AI model in addition to a current prompt sentence, for the purpose of conditioning the generated output.

The term “machine-readable format” refers to a data representation that is structured such that it can be directly processed by a computing device, without requiring manual interpretation by a human.

The term “parameter” refers to an individual element or value within structured data that represents a specific aspect of the avatar, such as a numerical level of talkativeness or a categorical value indicating a species type.

The term “computing device” refers to any hardware configuration, including at least one processor and a memory, capable of executing a generative AI model or other software modules for performing the processing described in the claims.

In one embodiment, a server, a terminal, and a user cooperate to realize a system for generating and controlling an avatar based on natural-language prompt sentences and subsequent dialogue, by using specific hardware and software components and defined data structures.

A server includes at least one processor, a main memory, a non-volatile storage device, and a network interface. The processor may be a central processing unit, a graphics processing unit, or a combination thereof. For high-throughput generative AI inference, the server preferably uses a graphics processing unit such as a general-purpose GPU capable of executing matrix operations in parallel. The memory stores executable instructions implementing a natural language processing module, a generative AI inference module, an image generation module, a dialogue management module, and a data storage module. The non-volatile storage device, such as a solid-state drive, stores a database containing avatar profiles, user histories, model configuration parameters, and cached intermediate data. The network interface communicates with one or more terminals through a communication network.

A terminal includes at least one processor, a display device, an input device such as a touch panel, a microphone, a speaker, a memory, and a network interface. The terminal executes an application that presents a graphical user interface, acquires user inputs, and exchanges data with the server. A user operates the terminal to input preferences and to interact with the avatar.

The server executes software implemented using a general-purpose programming language and a machine learning framework such as a tensor computation library. The server uses a transformer-based generative AI model as the generative AI model, where the model is composed of multiple layers of multi-head self-attention and feedforward sublayers, with residual connections and layer normalization. The model parameters include weight matrices for query, key, and value projections, weight matrices for feedforward projections, and embedding matrices for tokens and positional encodings. In one embodiment, the generative AI model is pre-trained on large-scale text data and fine-tuned on domain-specific data that includes examples of avatar descriptions and conversational styles.

The server uses a defined internal data structure for representing attribute information and feature data. For example, the server represents an avatar profile as a hierarchical object that includes fields for appearance, personality, and behavior patterns. Each field comprises a set of parameters. The appearance parameters may include species type, color scheme, style category, and expression type. The personality parameters may include talkativeness level, friendliness level, energy level, and calmness level. The behavior pattern parameters may include greeting style, topic preferences, and response tone classification. These parameters are represented as categorical values or numerical scales within bounded ranges.

The server applies natural language processing to a prompt sentence from the user to convert unstructured text into this structured parameter representation. The server uses a tokenizer compatible with the transformer-based generative AI model to convert the prompt sentence into token identifiers, which are then mapped to embedded vectors. The server can apply additional preprocessing such as lowercasing, Unicode normalization, and removal of unsupported characters. The natural language processing module may also use a lightweight classifier or rules to extract specific entities, such as animal names, personality adjectives, or activity keywords, from the text. By transforming the prompt sentence into structured attribute information before invoking the full generative AI model, the server reduces unnecessary model invocations and thereby improves computational efficiency.

The server uses the generative AI model to map the attribute information and the original prompt sentence into structured feature data. In one embodiment, the server constructs an internal instruction text that guides the generative AI model to output a structured description of an avatar. For example, when the user enters the prompt sentence “I like dogs and I enjoy talking. Please create a friendly dog avatar for me.” the server generates an instruction text that instructs the model to produce a description of appearance, personality, and behavior patterns. The generative AI model outputs a sequence of tokens that are decoded into text, which the server then parses into structured feature data. This process involves numeric computations in the transformer architecture, including matrix multiplications for attention and feedforward layers and nonlinear activation functions, executed efficiently on the GPU.

The server also constructs an image-generation prompt sentence from the structured feature data. For example, if the attribute information indicates species “dog,” style “cartoon,” and expression “smiling,” the server may generate an image-generation prompt sentence such as “cute cartoon dog avatar, brown color, smiling expression, bright colors, simple background.” The server supplies this image-generation prompt sentence to an image generative model such as a diffusion model implemented on the GPU. The diffusion model internally applies a denoising process parameterized by learned weights and a noise schedule. The diffusion model receives a latent representation and iteratively refines it through time steps according to a learned denoising network. During each step, the model computes gradients of a loss function that measures deviation from a target distribution and updates activations accordingly. Because the server automatically translates structured feature data into image-generation prompt sentences in a machine-optimized way, the system uses the image generative model consistently and reduces the number of failed image generations.

The server stores the resulting feature data and image references as an avatar profile in a database. The database may be an indexed relational database or a document-oriented database. The server assigns a unique identifier to each avatar profile, which is used when the user resumes interaction or requests updates. The database schema organizes avatar profiles with separate fields for appearance, personality, behavior patterns, visual assets, and conversation configuration, thereby improving data retrieval performance when only specific parts of the profile need to be modified.

The server additionally maintains a conversation configuration for each avatar. The server uses the generative AI model or a separate conversational model to produce configuration parameters, such as example greeting messages, default topics, and safety constraints, by submitting an internal instruction text derived from the avatar's feature data. As one example, when a user asks for a quiet cat avatar, the user may provide a prompt sentence such as “I love cats and prefer a quiet, gentle avatar.” The server then generates an internal instruction text that instructs the model to define greeting styles and response tones consistent with a quiet, gentle cat. The resulting configuration is stored as part of the avatar profile. This approach leads to a reusable conversation configuration that can be applied to multiple dialogue turns without re-generating it each time.

The terminal acquires prompt sentences from the user and displays the avatar image and dialogue messages. The terminal can be implemented with a graphical interface framework that uses the terminal processor and graphics hardware to render images and text at a given frame rate. The terminal decodes image data received from the server using image decoding routines and graphics APIs and displays it on the display device. The terminal also captures user input through the touch panel and optional microphone. In this embodiment, the terminal may additionally run a speech-to-text library supplied by the operating system to convert audio captured by the microphone into text. The terminal formats user messages and prompt sentences into structured request data and transmits them to the server through a secure communication protocol. The terminal therefore acts as a front-end controller that integrates the user and the avatar back-end.

The server uses a dedicated dialogue management module to coordinate multiple dialogue turns. The server maintains a conversation history per user or per avatar profile. The history includes a sequence of dialogue messages and response messages along with timestamps and optionally derived emotional state annotations. The server stores the history in memory and, when necessary, in the database. For subsequent interactions, the server uses a subset of the history as context when constructing new conversation-generation prompt sentences. By including only a subset selected according to relevance criteria, such as recency or emotional impact, the server limits input length and reduces computational cost while preserving necessary context. This selection involves computing a relevance score for each past message based on time decay and keyword matching.

The server estimates an emotional state of the user based on analysis of dialogue messages and response messages. In one embodiment, the server employs an auxiliary classifier model, such as a smaller neural network with layers for text embedding, pooling, and classification, trained to output probabilities for emotional categories. The server feeds the dialogue message or a combined message-response pair into this classifier. The classifier uses an embedded representation derived from a text encoder, such as a smaller transformer or a bidirectional recurrent unit with attention, and generates a vector of probabilities for emotions like “lonely,” “happy,” “sad,” or “anxious.” The server then thresholdizes or selects the largest probability to determine the emotional state. This approach yields a quantitative emotional estimate that can be incorporated into the avatar feature data.

The server updates at least part of the feature data and conversation-generation prompt sentences according to the estimated emotional state. For example, when the classifier detects a high probability of loneliness, the server may increase the talkativeness level parameter and adjust the greeting style parameter to more supportive messages. The server also modifies the next conversation-generation prompt sentence to explicitly include emotional context such as “Respond kindly and supportively because the user feels lonely.” By directly embedding emotional context into the prompts supplied to the generative AI model, the system constrains generation to a narrower semantic region and reduces the likelihood of inappropriate or non-supportive responses.

The server thereby improves the precision and stability of model outputs by using structured data and emotional annotations as conditioning signals. Because the avatar feature data is parameterized and stored, the server can adjust individual parameters, such as tone or preferred topics, without regenerating the entire avatar. This fine-grained control reduces redundant operations, optimizes data flow, and minimizes the size of updates that need to be sent to the terminal, which in turn reduces communication overhead.

The server uses a learning procedure for the generative AI model that further enhances technical performance. In one embodiment, the server trains the model using supervised fine-tuning on a dataset of prompt sentences, avatar feature descriptions, and dialogue examples. The training process uses a loss function such as cross-entropy loss between predicted tokens and ground-truth tokens. During training, the server uses gradient-based optimization, such as stochastic gradient descent with adaptive learning rates, to update weight parameters. The training data can be augmented through operations like synonym replacement, paraphrasing, or mask-based perturbations to increase robustness to varied user phrasing. The server may also use reinforcement learning criteria where human or synthetic feedback on the appropriateness of avatar responses is converted into a reward signal that biases the model toward more suitable outputs.

The server uses a modular architecture that separates prompt analysis, feature generation, image generation, dialogue response generation, emotional state estimation, and profile updating. Each module has well-defined input and output data structures, and communication between modules is implemented using serialized objects or internal APIs. This modular separation enables independent scaling of modules and targeted optimization for performance; for instance, the emotional state estimation module can run on a separate accelerator to offload some computational load.

This system produces a technical effect that goes beyond mere automation of human tasks. By converting unstructured prompt sentences into structured parameters, the server reduces ambiguity in data representation and improves the efficiency of generative AI model inference. The structured avatar profile allows the server to maintain a consistent state over many interactions and to apply incremental changes, leading to faster response times and fewer computational resources than systems that recompute entire avatar states. The integration of emotional state estimation and history-based context selection into prompt generation ensures that the generative AI model operates under more precise conditions, which empirically reduces error rates in response appropriateness and increases stability of the model outputs.

In another embodiment, the server may deploy multiple generative AI models specialized for different tasks. For example, one model specialized in trait extraction may be smaller and optimized for speed, used primarily for initial avatar creation based on a prompt sentence such as “Create a cheerful, energetic human avatar who likes games and anime.” Another model specialized in dialogue generation may be larger and optimized for conversational quality and context handling. The server selects which model to use based on the task, thereby improving overall computational efficiency and latency characteristics.

In yet another embodiment, the terminal may cache a subset of avatar feature data and recent dialogue history locally. When communication with the server is temporarily unavailable, the terminal can execute a smaller on-device model or rule-based approximation to generate simple responses. When connectivity is restored, the terminal synchronizes cached history with the server. This hybrid architecture allows the system to continue providing some level of interaction while preserving the benefits of server-side generative AI processing when available.

In a further embodiment, the server may control animations on the terminal based not only on discrete parameters but also on continuous values such as emotion intensity scores. For example, the server may send a normalized emotional intensity value together with the response message, and the terminal maps this value to animation parameters such as speed or amplitude through a predefined function. This mapping ensures a smooth and consistent visual reaction that corresponds to subtle differences in emotional state. As a result, the system provides a more natural and technically coherent experience, by aligning visual behavior with computed internal states.

By using these concrete hardware and software configurations, defined data structures, and explicit algorithmic flows, the system improves the way computers process natural language input, manage long-term avatar states, and generate highly contextual responses and images. The system thereby enhances processing speed, reduces resource usage, and improves accuracy and consistency of avatar behavior relative to prior, less-structured approaches.

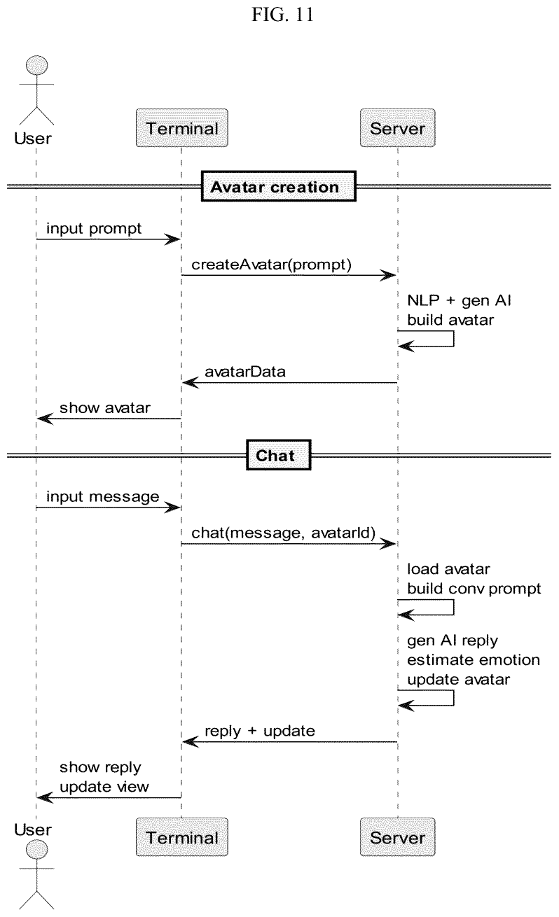

The following describes the processing flow using FIG. 11.

### Step 1

User operates the terminal to initiate avatar creation and inputs a prompt sentence.
User views an input screen displayed by the terminal and types a natural-language description such as “I like dogs and I enjoy talking. Please create a friendly dog avatar for me.” or “I love cats and prefer a quiet, gentle avatar.”
Input: Raw text entered by the user via a keyboard or speech-to-text module.
Output: A UTF-8 encoded prompt sentence stored in the terminal's memory.

### Step 2

Terminal packages the user's prompt sentence and sends it to the server.
Terminal constructs a request object that includes at least the prompt sentence and a user identifier, serializes the object into a structured format, and transmits it to the server over a network connection.
Input: The UTF-8 prompt sentence and associated user metadata.
Output: A network request containing structured input information delivered to the server.

### Step 3

Server receives the request and validates the input information.
Server reads the structured request, checks that the prompt sentence is present and within a permitted length, verifies basic authentication, and discards or truncates invalid or excessively long content.
Input: Structured input information received from the terminal.
Output: A validated prompt sentence and associated user identifier, or an error response if validation fails.

### Step 4

Server preprocesses the prompt sentence and extracts preliminary attribute information.
Server normalizes the text (for example, Unicode normalization, lowercasing, whitespace trimming), applies tokenization or rule-based pattern matching to identify keywords such as “dog,” “cat,” “talkative,” “quiet,” and generates preliminary attributes representing user preferences.
Input: Validated prompt sentence from Step 3.
Output: A cleaned prompt sentence and a preliminary attribute set indicating candidate appearance and personality traits.

### Step 5

Server converts the cleaned prompt sentence into token identifiers for the generative AI model.
Server uses a tokenizer associated with a transformer-based generative AI model to segment the prompt sentence into tokens, maps each token to an integer identifier, and constructs model inputs including token sequences and attention masks.
Input: Cleaned prompt sentence from Step 4.
Output: Tokenized model input data suitable for execution on the generative AI model.

### Step 6

Server executes the generative AI model to generate structured avatar feature data.
Server feeds the tokenized input, optionally combined with the preliminary attribute set, into the generative AI model, performs matrix multiplications and attention operations on a processor such as a GPU, and decodes the output tokens to obtain a structured description of appearance, personality, and behavior patterns.
Input: Tokenized model input data and preliminary attribute information from Steps 4 and 5.
Output: Unparsed structured text describing avatar appearance, personality, and behavior patterns.

### Step 7

Server parses the generated text to obtain machine-readable feature data and constructs an avatar profile.
Server applies a parser to the generated structured text, converts it into a hierarchical data object with explicit fields for appearance parameters, personality parameters, and behavior pattern parameters, and assigns a unique avatar identifier.
Input: Generated structured text from Step 6.
Output: A machine-readable avatar profile including structured feature data and an avatar identifier.

### Step 8

Server generates an image-generation prompt sentence from the avatar feature data and invokes an image generative model.
Server reads key appearance parameters such as species, style, color, and expression from the avatar profile, composes an image-generation prompt sentence such as “cute cartoon brown dog avatar, smiling expression, bright colors, simple background,” and supplies this prompt to an image generative model that performs iterative denoising computations to create an image.
Input: Avatar feature data contained in the avatar profile from Step 7.
Output: Avatar image data representing the visual appearance of the avatar.

### Step 9

Server integrates the generated image data into the avatar profile and stores the profile.
Server associates the generated image data or its storage reference with the avatar identifier, updates the avatar profile to include visual asset information, and writes the avatar profile to a persistent database.
Input: Avatar profile from Step 7 and avatar image data from Step 8.
Output: A stored avatar profile containing feature data and visual asset information.

### Step 10

Server sends the avatar feature data and image data to the terminal.
Server retrieves the relevant portions of the avatar profile, serializes the feature data and visual asset information, and transmits them to the terminal as a structured response.
Input: Stored avatar profile from Step 9 and a pending request from the terminal.
Output: A response message containing avatar feature data and image data delivered to the terminal.

### Step 11

Terminal receives the avatar data and renders the avatar.
Terminal parses the response message, decodes the image data or fetches image resources as needed, and displays the avatar image and summary of personality or behavior traits on the display device.
Input: Response message with avatar feature data and image data from Step 10.
Output: A visual representation of the avatar and initial descriptive information presented to the user.

### Step 12

User begins interaction with the avatar by sending a dialogue message.
User views the avatar display on the terminal and enters a free-form dialogue message such as “I felt lonely today. Can we talk?” or “Tell me something funny.” through the input interface.
Input: User's conversational text entered via the terminal.
Output: A dialogue message stored on the terminal and prepared for transmission to the server.

### Step 13

Terminal packages the dialogue message and sends it to the server along with avatar identification.
Terminal constructs a structured request containing the dialogue message, avatar identifier, and optionally part of the local conversation history, and transmits it to the server over the network.
Input: Dialogue message from Step 12 and avatar identifier from the stored avatar profile.
Output: A conversation request delivered to the server including current dialogue content and avatar context.

### Step 14

Server retrieves the avatar profile and constructs a conversation-generation prompt sentence.
Server reads the avatar profile from the database using the avatar identifier, selects relevant personality and behavior pattern parameters, optionally extracts a subset of prior dialogue history, and embeds this information into a conversation-generation prompt sentence that instructs the generative AI model how the avatar should respond.
Input: Conversation request from Step 13 and avatar profile from storage.
Output: A conversation-generation prompt sentence and associated context data ready for model inference.

### Step 15

Server executes the generative AI model to generate a response message for the avatar.
Server tokenizes the conversation-generation prompt sentence, feeds the tokens and context into the generative AI model, performs the required numerical operations on the processor, and decodes the resulting output tokens into a natural-language response consistent with the avatar's personality and behavior patterns.
Input: Conversation-generation prompt sentence and context data from Step 14.
Output: A natural-language response message corresponding to the avatar's reply.

### Step 16

Server estimates the user's emotional state based on the dialogue message and response message.
Server passes the dialogue message and the generated response message through an emotional state classifier, computes an embedded representation of the text, and applies classification weights to obtain probabilities for different emotional categories such as loneliness or happiness, and then selects one or more categories as the estimated emotional state.
Input: User dialogue message from Step 13 and avatar response message from Step 15.
Output: An estimated emotional state value or vector associated with the current interaction.

### Step 17

Server updates the avatar feature data and conversation-generation prompt parameters according to the estimated emotional state.
Server adjusts specific parameters of the avatar profile, such as increasing talkativeness or changing greeting style, and modifies stored or future conversation-generation prompt templates to explicitly incorporate the emotional context, thereby updating the avatar's reaction characteristics.
Input: Avatar profile from Step 14 and estimated emotional state from Step 16.
Output: An updated avatar profile and adjusted conversation-generation prompt parameters reflecting the user's emotional state.

### Step 18

Server sends the generated response message and any updated reaction characteristics to the terminal.
Server encapsulates the avatar's response text and, if necessary, updated reaction-related parameters or auxiliary values into a structured response and transmits it to the terminal for display and animation control.
Input: Response message from Step 15 and updated avatar profile data from Step 17.
Output: A response payload containing the avatar reply and updated reaction information delivered to the terminal.

### Step 19

Terminal displays the response message and updates the avatar's behavior accordingly.
Terminal renders the avatar's response text as a chat bubble, interprets any updated reaction parameters or auxiliary values to adjust animations or visual cues, and stores the interaction in local history.
Input: Response payload from Step 18.
Output: A displayed conversational reply and adjusted visual behavior of the avatar observable by the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented shopping assistance systems typically present static recommendation lists or generic virtual agents whose behavior is only loosely coupled to underlying user modeling and recommendation algorithms. In many architectures, user behavior logs are merely used offline to compute recommendation scores, and the user interface layer simply renders precomputed items or scripted dialogues. As a result, the processing performed by the processor is not structured to dynamically integrate user profiling, generative response generation, and feedback-based optimization as a unified computational workflow. This leads to several technical limitations.

First, conventional systems often maintain user preference data and virtual agent behavior parameters in separate subsystems that are not consistently synchronized. The processor generally executes separate modules for recommendation and for avatar rendering without a common representation or prompt structure that directly links user attribute information, product selection, and avatar dialogue content. Consequently, the system cannot efficiently adapt avatar appearance and conversational behavior to fine-grained changes in user interests detected from behavior history and real-time interaction data.

Second, conventional systems rely on rule-based or template-based response generation that does not leverage generative models driven by explicit prompt sentences including user attribute information and recommendation product information as structured inputs. The processor therefore consumes additional resources for manual rule management and suffers from limited scalability and flexibility, making it difficult to tailor system behavior to diverse users and evolving product catalogs.

Third, typical architectures do not utilize the interaction between the avatar and the user, including dialogue history and user operations on recommended products, as a closed feedback loop for updating both the user profile model and the recommendation model. The processor often records logs in a passive manner and does not actively use such logs as learning information to update the generation processing of user attribute information and recommendation product information, nor to dynamically optimize avatar appearance information, avatar personality information, and dialogue information. This results in suboptimal personalization, increased latency in model improvement, and inefficient use of computational resources.

Accordingly, there is a need for an improved computer-implemented system in which the processor is specifically configured to (i) generate user attribute information from behavior history information and preference information, (ii) generate prompt sentences that drive a generative information processing model to produce avatar-related feature information and dialogue information, (iii) integrate product recommendation processing with avatar dialogue generation, and (iv) use interaction-derived learning information to update the underlying generation processing. Such an architecture can improve the functioning of the computer system itself by providing a more efficient data flow, tighter coupling between models, and automated optimization of avatar behavior and recommendation logic.

The specific processing by the specific processing unit 290 of the data processing device 12 in Application Example 1 is realized by the following means.

The present invention provides a server comprising a processor configured to acquire user behavior history information and preference information, generate user attribute information indicating user interests based on the behavior history information and the preference information, generate a prompt sentence for input to a generative information processing model based on the user attribute information, input the prompt sentence to the generative information processing model to generate feature information including avatar appearance information and avatar personality information, generate visual representation data of an avatar based on the feature information, transmit the visual representation data and the avatar personality information to a terminal device in order to cause the terminal device to visually display the avatar in a virtual space, search product information stored in a product information storage device based on the user attribute information and input information from a user, generate recommendation product information by extracting products suitable for the user, generate a response prompt sentence for input to the generative information processing model based on the recommendation product information and the avatar personality information, input the response prompt sentence to the generative information processing model to generate dialogue information representing product introduction and dialogue responses by the avatar, transmit the dialogue information to the terminal device in order to cause the terminal device to present the recommendation product information via the avatar, collect dialogue history information between the avatar and the user and operation history information of the user with respect to the recommendation product information, generate learning information for updating the user attribute information and the recommendation product information based on the dialogue history information and the operation history information, and update generation processing of the user attribute information and the recommendation product information based on the learning information so as to dynamically optimize the avatar appearance information, the avatar personality information, and the dialogue information. This enables an improvement in computer functionality by structuring the processor to execute an integrated pipeline that tightly couples user profiling, generative model prompting, product recommendation, and feedback-driven optimization, thereby achieving more efficient use of computational resources, reduced manual rule management, and enhanced adaptability and responsiveness of the avatar-mediated interaction in a virtual shopping environment.

The term “user behavior history information” refers to information indicating past actions of a user in relation to one or more information processing services, including at least one of browsing records, selection records, purchase records, search records, and interaction records with a virtual agent, which is stored in a storage device and is processable by a processor.

The term “preference information” refers to information representing explicit or implicit likes, dislikes, priorities, or constraints of a user, including at least one of manually provided answers, rating values, category preferences, and inferred preference scores derived from user behavior history information.

The term “user attribute information” refers to structured information generated by a processor that represents at least one of interests, tendencies, budget ranges, and category affinities of a user, derived from user behavior history information and preference information, and used as an input condition for subsequent processing.

The term “generative information processing model” refers to an information processing model implemented by software and executed by hardware, which receives an input including a prompt sentence and generates, by probabilistic or statistical computation, new output information such as text, parameters, or control data that is not merely a retrieval of stored data.

The term “prompt sentence” refers to text data that is supplied as input to a generative information processing model and that specifies at least one of conditions, roles, constraints, and desired output formats, thereby guiding the generative information processing model to produce a corresponding output.

The term “feature information” refers to information generated by a generative information processing model that includes one or more elements representing characteristics of a virtual agent, such as avatar appearance information and avatar personality information, and that is used as a basis for constructing visual and behavioral representations of the avatar.

The term “avatar appearance information” refers to information describing visual characteristics of a virtual agent, including at least one of body shape, color, clothing, accessories, and graphical style, which can be converted by a processor or a rendering engine into visual representation data.

The term “avatar personality information” refers to information describing behavioral and conversational characteristics of a virtual agent, including at least one of tone of voice, formality level, attitude, typical expressions, and response policies, which is used to control dialogue information generated for the avatar.

The term “visual representation data” refers to data usable by a rendering module of a terminal device to visually display an object in a virtual space, including at least one of image data, three-dimensional model data, texture data, animation parameter data, and layout data.

The term “terminal device” refers to an information processing apparatus operated by a user, including at least one of a portable terminal, a head-mounted display device, and a stationary computing device, which is configured to communicate with a server, to display an avatar, and to accept user input.

The term “virtual space” refers to a computer-generated environment that is presented on a display device and in which one or more virtual objects, including an avatar and one or more representations of products, are visually arranged and can be interacted with by a user.

The term “product information storage device” refers to one or more storage units, implemented by hardware and managed by software, that store product information including at least one of identifiers, names, attributes, prices, and images of products, and that can be accessed by a processor for search and retrieval.

The term “product information” refers to information describing at least one product, including at least one of an identifier, a category, a specification, a price, an image reference, and a description, which is stored in a product information storage device and is usable for recommendation processing.

The term “recommendation product information” refers to information representing one or more products selected by a processor from product information based on user attribute information and user input information, and including at least a subset of attributes of the selected products used to present recommendations to a user.

The term “response prompt sentence” refers to a prompt sentence generated by a processor for input to a generative information processing model, which includes at least one of avatar personality information, recommendation product information, and user attribute information, and that is used to cause the generative information processing model to generate dialogue information.

The term “dialogue information” refers to information representing content of communication output by an avatar to a user, including at least one of textual expressions, structured dialogue acts, and instructions for accompanying non-verbal behavior, which is based on output from a generative information processing model.

The term “dialogue history information” refers to information indicating past exchanges between an avatar and a user, including at least user utterances, system responses, timestamps, and associated context data, which is stored in a storage device and is re-usable for analysis and learning.

The term “operation history information” refers to information indicating operations performed by a user with respect to recommendation product information or other interface elements, including at least one of selection operations, viewing operations, addition-to-cart operations, and purchase operations.

The term “learning information” refers to information derived from at least dialogue history information and operation history information, which is used by a processor to update parameters or rules of processes that generate user attribute information and recommendation product information.

The term “generation processing of the user attribute information and the recommendation product information” refers to a sequence of computational operations executed by a processor, including at least acquisition, analysis, and model-based inference, which takes user behavior history information and preference information as inputs and produces updated user attribute information and recommendation product information as outputs.

The term “dynamically optimize” refers to modifying, by execution of a processor during operation of a system, at least one of avatar appearance information, avatar personality information, and dialogue information, based on learning information, such that system behavior is adaptively adjusted without manual rule rewriting.

In one embodiment, a server, a terminal, and a user cooperate to implement the claimed system. The server comprises at least one processor, a main memory, a non-volatile storage device, and a network interface. The processor of the server executes stored programs to perform user profiling, prompt sentence generation, generative AI model inference, recommendation computation, and feedback-based optimization. The terminal comprises at least one processor, a display device, an input device, a communication interface, and, in some cases, a head-mounted display and motion sensors. The user operates the terminal to access a virtual space, to interact with an avatar, and to select products.

The server uses general-purpose computing hardware, such as a multi-core central processing unit and one or more graphics processing units. The server stores and executes software components including an operating system, a database management system, and machine learning frameworks such as TensorFlow and PyTorch, as well as a rendering-independent application server. The server also communicates with an external generative AI service that provides a generative AI model. The generative AI model is, in one embodiment, a large-scale neural network configured for natural language generation and trained on language data. The server accesses the generative AI model via an application programming interface (API) using a communication protocol such as HTTPS.

The terminal executes an application program, such as a mobile application or a head-mounted display application, that includes a user interface rendering engine, for example a game engine such as Unity or a similar graphics framework. The terminal displays a virtual space representing a store-like environment and renders an avatar using graphical assets received from the server. The terminal collects user input by touch operations, controller operations, or voice input, and transmits such input to the server.

The server stores user behavior history information and preference information in one or more storage devices. The server represents the user behavior history information as structured records, for example as a sequence of tuples including a user identifier, a timestamp, a product category identifier, an operation type, and contextual attributes. The preference information is stored as key-value pairs indicating explicit preferences (for example, declared favorite categories, maximum price ranges) and as numerical scores indicating inferred affinities for categories, brands, or product attributes. The server maintains these records in database tables or in key-value stores, and uses indexing structures to quickly query and aggregate them.

The server executes a profiling module implemented by a machine learning framework such as TensorFlow. The profiling module constructs feature vectors from the user behavior history information and the preference information. The server encodes categorical variables such as product category identifiers, brand identifiers, and operation types using embedding vectors. The server normalizes continuous variables such as prices or time intervals, and concatenates these into fixed-length numerical arrays. The server inputs these feature vectors into a neural network, for example a multilayer perceptron having several hidden layers with rectified linear unit activation functions. The server trains this neural network offline by minimizing a loss function such as cross-entropy loss or mean squared error that measures the difference between predicted user interests and ground-truth labels derived from historical data. The server updates the weights of the network by backpropagation and an optimization method such as stochastic gradient descent or Adam. After training, the server uses the neural network to infer user attribute information in real time.

The user attribute information generated by the server includes, for example, probabilities or scores indicating that the user is interested in certain product categories, such as outdoor equipment, pet-related goods, or fashion items. The server aggregates the outputs of the neural network into a structured representation that contains, for example, interest scores per category, a budget range estimate, and a sensitivity to brand or novelty. The server stores this user attribute information in a profile store, where it is available for subsequent processing.

The server generates a prompt sentence for input to the generative AI model based on the user attribute information. The server executes a prompt construction module that inserts the user attribute information into predefined natural language templates. For example, the server generates a prompt sentence such as:
“User profile: loves dogs, frequently buys camping and outdoor products, prefers mid-range prices.
You are a generative AI model that designs a virtual shopping avatar.
Create a detailed specification for an avatar that appears as a friendly dog who enjoys outdoor activities.
Describe: (1) visual appearance, (2) personality traits, (3) tone of voice, and (4) how the avatar should recommend products in a virtual store.”

The server transmits this prompt sentence to the generative AI model via an API client. The generative AI model is, for example, a transformer-based neural network that includes an input embedding layer, multiple self-attention layers, and a final output projection layer. The model receives the prompt sentence as a token sequence, applies self-attention operations that compute attention scores between tokens, and generates a probability distribution over possible next tokens at each time step. The server specifies model parameters such as temperature, maximum output length, and top-k sampling thresholds, and receives generated text as the model's output.

The server parses the output of the generative AI model to extract feature information. The feature information includes, for example, avatar appearance information such as “a medium-sized brown dog wearing a hiking backpack and a green scarf” and avatar personality information such as “friendly, energetic, uses casual language, emphasizes outdoor safety and comfort.” The server stores the feature information in a structured format, separating visual descriptions from personality descriptions. The server can apply a rule-based parser that searches for predefined section markers or keyword patterns in the generated text, in order to map parts of the text to predetermined fields.

The server optionally uses an image generation model to produce visual representation data of the avatar. The server, in this case, uses the avatar appearance information as a textual condition for the image generation model. The image generation model is, in one embodiment, a diffusion-based generative model that progressively denoises a random tensor conditioned on text embeddings. The server executes the image generation model on a graphics processing unit and produces an image array representing the avatar's appearance. The server encodes the image array into a standard image format such as PNG or JPEG and stores it in an object storage system. The server records a resource identifier for this image in association with the avatar appearance information.

The server then transmits the avatar appearance information, the avatar personality information, and, when available, the image resource identifier to the terminal. The terminal receives these data via a network interface, stores them temporarily, and uses the avatar appearance information to configure a graphical character. The terminal uses a graphics engine such as Unity to load the image as a texture or to map the appearance description to a pre-assembled three-dimensional model. The terminal sets animation parameters or state machines based on the avatar personality information, for example by selecting more energetic gestures and faster speech when the personality is friendly and active.

The user uses the terminal to view the avatar and to enter requests. The user may, for example, speak a request such as “Show me lightweight tents I can use when camping with my dog.” The terminal records audio via a microphone and applies a speech recognition function. The terminal or the server converts the audio to a text string and sends this text string and context information, such as the current location in the virtual space, to the server.

The server receives the text input as user input information. The server interprets this user input information in combination with the user attribute information. The server executes an intent recognition module that uses a neural network classifier or a rule-based classifier to map the text input to an intent class, such as “request_tent_recommendation,” and to extract parameters, such as “lightweight” and “for use with dog.” The server constructs query constraints from these parameters and the user attribute information.

The server searches a product information storage device using the query constraints. The server may use a relational database or a search index, such as an inverted index over product descriptions, to retrieve candidate products. The server can also execute a recommendation model implemented with TensorFlow or PyTorch. This recommendation model can be, for example, a neural collaborative filtering model or a gradient-boosted decision tree model that takes as inputs user attribute information and product feature vectors and outputs scores representing relevance. The server ranks the candidate products according to these scores and selects a subset, for example the top N items.

The server generates recommendation product information from the selected products. The recommendation product information includes identifiers, names, prices, main characteristics, and image references. The server then generates a response prompt sentence for the generative AI model that includes the recommendation product information, the avatar personality information, and the user attribute information. For example, the server generates a response prompt sentence such as:
“You are a dog-shaped avatar in a virtual outdoor gear store.
User profile: loves dogs, interested in camping and outdoor activities, prefers mid-range prices.
Avatar personality: friendly, energetic, supportive.

### Recommended Products

1) ‘TrailLite Tent A’—lightweight, two-person, dog-friendly vestibule.
2) ‘CampBreeze Tent B’—ultra-light, one-person, water-resistant.
The user says: ‘Show me lightweight tents I can use when camping with my dog.’
As the avatar, explain 2-3 suitable products in a concise and friendly tone. Mention why each product is good for camping with a dog.”

The server sends this response prompt sentence to the generative AI model via the API. The generative AI model, using its transformer architecture, produces a coherent dialogue response that aligns with the avatar's role and the recommendation product information. The server receives the generated text and may perform safety filtering and length control by applying heuristic rules or additional classifiers. The server associates parts of the generated text with specific product identifiers, for example by scanning for product names or index markers.

The server transmits the dialogue information and the recommendation product information to the terminal. The terminal receives the dialogue information and uses a text-to-speech engine to synthesize audio output. The terminal animates the avatar according to the speech and gestures extracted from the dialogue information, and displays product panels or three-dimensional models around the avatar. The terminal associates user-selectable regions with the products referenced in the dialogue.

The user interacts with the presented recommendations by selecting products, opening detailed views, or adding items to a shopping cart. The terminal records these user operations as operation history information. The terminal timestamps each operation and includes identifiers of the products and the user session. The terminal periodically or incrementally sends this operation history information and the dialogue history information, which includes user utterances and avatar responses, to the server.

The server records the dialogue history information and the operation history information in log storage. The server uses this log data to generate learning information. The server may compute statistics such as click-through rates per type of recommendation prompt, conversion rates for particular avatar personalities, or dwell times across different product categories. The server can also create training datasets from sequences of user attribute information, recommendation product information, dialogue information, and observed user operations. The server labels these sequences, for example, as successful or unsuccessful recommendations based on whether the user performed purchase-related actions.

The server uses the learning information to update the generation processing of the user attribute information and the recommendation product information. In one embodiment, the server retrains the profiling neural network and the recommendation model using the new log data. The server defines loss functions that penalize inaccurate interest predictions or poorly performing recommendations. The server applies data augmentation techniques, such as random subsampling of sessions or noise injection into feature vectors, to improve robustness. The server updates model weights by gradient descent methods and validates the updated models on reserved validation sets. When the updated models show improved performance metrics, such as increased prediction accuracy or recommendation click-through rate, the server deploys the updated models.

The server further uses the learning information to adjust avatar appearance information and avatar personality information. For example, if the learning information indicates that a particular avatar style leads to higher engagement in a certain user segment, the server can modify the prompt sentences used for avatar generation to emphasize that style for similar users. The server can generate higher-level prompts to the generative AI model that request updated personality descriptions based on summarized interaction outcomes. By systematically linking learning information to changes in prompt structure and model selection, the server implements a closed-loop optimization that is not readily achievable by manual rule editing.

The technical effects of the described configuration include improved computational efficiency and personalization accuracy. Because the server encodes user attribute information in a structured form and directly injects this information into prompt sentences, the generative AI model receives more precise context, reducing the need to infer user preferences from scratch at each interaction. This reduces unnecessary token processing and leads to faster generation and shorter response latency. Furthermore, the integration of recommendation product information into the response prompt sentence causes the generative AI model to produce responses that are constrained by actual product data, which reduces hallucinations and improves factual accuracy.

The use of learned neural networks for user profiling and recommendation, while conventional in isolation, is combined here with a specific prompt sentence protocol, data structures, and feedback loop that yield improved overall system behavior. The server avoids simply automating human decision-making; instead, the server configures the processor to execute non-conventional sequences of data transformations, including embedding-based feature construction, transformer-based language generation conditioned on structured recommendation data, and retraining triggered by behavior-derived learning information. These sequences are designed to optimize hardware resource usage by reusing shared user attribute information across multiple modules and by adjusting prompt length and model parameters based on learned effectiveness, which reduces redundant computation and network traffic.

The system improves data management by maintaining unified profile representations and by structuring logs to directly support retraining pipelines. This arrangement enables the server to quickly adjust personalization strategies without reconfiguring front-end code at the terminal. Additionally, communication load is reduced by sending compact identifiers and condensed attribute vectors, rather than full rule sets or static script libraries, from the server to the terminal.

Alternative embodiments are possible. The server may implement the profiling module as a sequence model, such as a recurrent neural network or a transformer encoder, that considers the order of user actions over time to model interest dynamics. The recommendation model can be, in another embodiment, a two-tower architecture in which one tower encodes user attributes and the other tower encodes product features, with similarity computed via inner products. The generative AI model can be replaced by a model specialized for conversational recommendation that includes additional control tokens for persona and style.

The terminal may be a head-mounted display that tracks head orientation and hand controllers, and uses these signals to determine gaze and pointing gestures. The terminal then reports these signals as part of the operation history information, enabling the server to use gaze duration or spatial focus as additional features for learning. The server can integrate these features into the profiling and recommendation models to further refine user attribute information.

In another embodiment, the server adjusts prompt sentences based on network conditions or available computation. For example, when bandwidth is limited, the server generates shorter prompts and elicits shorter responses, thereby reducing token counts and API latency. The server, in this case, configures simplified templates that still carry essential user attribute information and recommendation product information.

By structuring the system as described, the server, the terminal, and the user cooperate in a manner that improves computer technology itself. The server implements specific data structures, model architectures, and prompt protocols that enable more accurate, faster, and more resource-efficient generation of avatar-based recommendations. The closed-loop learning configuration ensures that the processor continually tunes parameters and prompt strategies based on measured outcomes, thereby providing a dynamic optimization that is not achievable by static rule-based user interfaces.

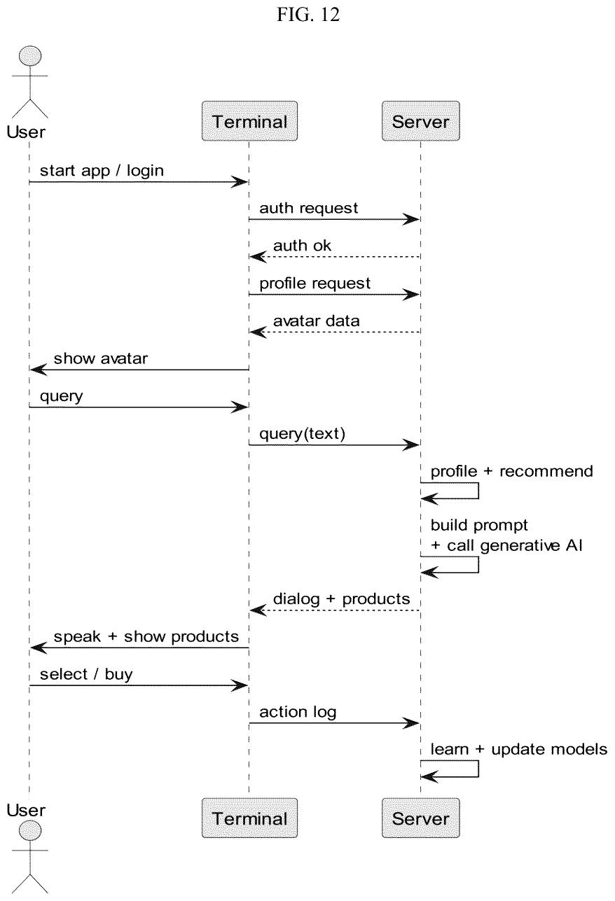

The following describes the processing flow using FIG. 12.

### Step 1

The terminal starts an application and establishes a session with the server.
The terminal displays a login or start screen and acquires user credentials or a device identifier from the user as input. Based on this input, the terminal generates a session establishment request including the credentials and device information and transmits the request to the server. The output of the terminal in this step is a structured session request message sent over a network connection.

### Step 2

The server authenticates the user and initializes user-related data.
The server receives the session request message as input and compares the included credentials against records stored in an authentication database. The server executes comparison operations and hashing operations to verify the credentials, and, when successful, generates a session token and retrieves basic user settings. The output of the server in this step is a response message containing the session token and user identifier, which is transmitted back to the terminal.

### Step 3

The terminal prepares a virtual space and requests profile information.
The terminal receives the session token and user identifier as input and stores them in volatile memory. The terminal initializes a virtual space by loading layout data and user interface resources from local storage, and then generates a profile request message that includes the user identifier and session token. The output of the terminal in this step is the profile request message transmitted to the server.

### Step 4

The server retrieves user behavior history information and preference information.
The server receives the profile request message as input and queries one or more databases storing user behavior history information and preference information. The server performs index lookups and filtering operations to extract records such as past purchases, item views, and preference settings. The output of the server in this step is a collection of behavior history records and preference records, formatted as structured data ready for feature extraction.

### Step 5

The server generates feature vectors and computes user attribute information.
The server uses the behavior history records and preference records as input and executes a profiling module implemented with a machine learning framework. The server encodes categorical values into embeddings, normalizes numerical values, and concatenates them into fixed-length feature vectors. The server inputs these feature vectors into a trained neural network model and performs forward propagation to obtain prediction scores for various interest categories and preference dimensions. The output of the server in this step is user attribute information that includes, for example, interest scores, budget range estimates, and category affinities.

### Step 6

The server constructs a prompt sentence for avatar specification and calls the generative AI model.
The server takes the user attribute information as input and executes a prompt construction routine that inserts elements of the user attribute information into natural language templates. The server thereby generates a prompt sentence, such as:
“User profile: loves dogs, frequently buys camping and outdoor products, prefers mid-range prices.
You are a generative AI model that designs a virtual shopping avatar.
Create a detailed specification for an avatar that appears as a friendly dog who enjoys outdoor activities.
Describe: (1) visual appearance, (2) personality traits, (3) tone of voice, and (4) how the avatar should recommend products in a virtual store.”
The server sends this prompt sentence as input to a generative AI model via an API and receives generated text describing avatar appearance and personality. The output of the server in this step is feature information including avatar appearance information and avatar personality information derived from the generated text.

### Step 7

The server generates visual representation data of the avatar.
The server uses the avatar appearance information as input and either selects a predefined graphical asset or calls an image generation model. When using an image generation model, the server transforms the appearance information into a textual condition, executes a diffusion-based or similar algorithm on a graphics processing unit, and obtains an image array. The server encodes the image into a standard format and stores it in storage, associating the file location with the avatar identifier. The output of the server in this step is visual representation data, such as an image reference and rendering parameters, combined with avatar personality information.

### Step 8

The server transmits avatar data to the terminal.
The server takes the visual representation data and avatar personality information as input and assembles an avatar data package including an avatar identifier, image references, and personality parameters. The server transmits this package over the network to the terminal. The output of the server in this step is the avatar data package message sent to the terminal.

### Step 9

The terminal renders and displays the avatar in the virtual space.
The terminal receives the avatar data package as input and loads the referenced image or three-dimensional model using a graphics engine. The terminal maps the image or model to an avatar object, assigns position and animation states in the virtual space, and configures behavior parameters based on the avatar personality information. The output of the terminal in this step is a visually displayed avatar in the virtual space, ready to interact with the user.

### Step 10

The user initiates interaction with the avatar.
The user observes the displayed avatar and provides input, such as a spoken request or a text query, for example, “Show me lightweight tents I can use when camping with my dog.” The user's speech or text is the input to the terminal. The output of the user in this step is the interaction content, delivered via the terminal's input interface.

### Step 11

The terminal captures user input and generates an interaction request.
The terminal receives the user's spoken or typed input as input data. When the input is spoken, the terminal records audio samples and applies speech recognition to convert the audio into a text string. The terminal then constructs an interaction request message that includes the recognized text, the current avatar identifier, the user identifier, and contextual information such as the current region of the virtual space. The output of the terminal in this step is the interaction request message transmitted to the server.

### Step 12

The server interprets user intent and prepares a product search query.
The server receives the interaction request message as input and executes an intent recognition module. The server applies either a neural network classifier or rule-based pattern matching to the text string in order to detect an intent class and extract parameters such as desired product category and constraints (for example, “tent,” “lightweight,” “for use with dog”). The server then constructs structured query conditions that combine the extracted parameters with user attribute information previously computed. The output of the server in this step is a structured query object suitable for product information retrieval.

### Step 13

The server searches product information and selects recommended products.
The server uses the structured query object as input and accesses a product information storage device. The server executes database queries or search index lookups to retrieve candidate products that match the category and constraint conditions. The server optionally applies a recommendation model that computes a relevance score for each candidate based on user attribute information and product features. The server ranks the candidates according to the scores and selects a subset as recommended products. The output of the server in this step is recommendation product information that includes identifiers, names, attributes, and prices of the selected products.

### Step 14

The server constructs a response prompt sentence and calls the generative AI model for dialogue generation.
The server takes the recommendation product information, the avatar personality information, and the user attribute information as input. The server generates a response prompt sentence by embedding details of the recommended products and personality parameters into a natural language template, for example:
“You are a dog-shaped avatar in a virtual outdoor gear store.
User profile: loves dogs, interested in camping and outdoor activities, prefers mid-range prices.
Avatar personality: friendly, energetic, supportive.

### Recommended Products

1) ‘TrailLite Tent A’—lightweight, two-person, dog-friendly vestibule.
2) ‘CampBreeze Tent B’—ultra-light, one-person, water-resistant.
The user says: ‘Show me lightweight tents I can use when camping with my dog.’
As the avatar, explain 2-3 suitable products in a concise and friendly tone. Mention why each product is good for camping with a dog.”
The server sends this response prompt sentence as input to the generative AI model and receives generated dialogue text that describes and recommends the products. The output of the server in this step is dialogue information that represents the avatar's verbal response.

### Step 15

The server links dialogue text to product identifiers and sends a response to the terminal.
The server receives the generated dialogue information as input and analyzes the text to detect references to specific products, for example by matching product names or index numbers. The server associates portions of the text with corresponding product identifiers and, if necessary, truncates or reformats the text to fit display constraints. The server then assembles a response message that includes the dialogue information and the recommendation product information, and transmits this message to the terminal. The output of the server in this step is the response message delivered to the terminal.

### Step 16

The terminal presents the dialogue and recommended products to the user.
The terminal receives the response message as input and passes the dialogue text to a text-to-speech engine to generate audio output. The terminal activates avatar talking animations in synchrony with the audio and displays on-screen subtitles if required. The terminal visually presents recommended products near the avatar in the virtual space, loading product images or models and placing them in navigable positions. The output of the terminal in this step is a synchronized visual and auditory presentation of the avatar's explanation and the recommended products.

### Step 17

The user interacts with recommended products.
The user observes the presented products and operates the terminal to perform actions such as selecting a product, opening a detail view, or adding a product to a cart. The user's selections, taps, or gestures serve as input to the terminal. The output of the user in this step is a series of interaction events that indicate interest or disinterest in particular products.

### Step 18

The terminal records operation history information and sends it to the server.
The terminal receives the user's interaction events as input and attaches timestamps and product identifiers to each event. The terminal stores these operation records temporarily and periodically generates an operation history message that includes the recorded events and the associated dialogue context, such as the last prompt and response. The terminal transmits this message to the server. The output of the terminal in this step is structured operation history information and dialogue history information sent to the server.

### Step 19

The server generates learning information from dialogue history and operation history.
The server receives the operation history information and dialogue history information as input and writes them to log storage. The server computes statistics such as click-through ratios, purchase rates, and abandonment patterns by aggregating the logs. The server also constructs training samples that pair user attribute information and recommendation product information with subsequent user operations. The server labels these samples according to success criteria, for example “clicked,” “purchased,” or “ignored.” The output of the server in this step is learning information that summarizes performance and provides labeled data for model updates.

### Step 20

The server updates models and prompt strategies based on learning information.
The server uses the learning information as input for retraining or fine-tuning the profiling model and the recommendation model. The server executes training procedures that compute gradients of a loss function with respect to model parameters and apply optimization steps to improve performance. The server evaluates updated models on validation subsets of the learning information and, when improvement is confirmed, deploys the new models. The server may also adjust prompt sentence templates or parameter settings based on patterns found in the learning information, such as effectiveness of particular phrasing. The output of the server in this step is updated model parameters and revised prompt strategies that will be used for subsequent user sessions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented avatar systems and health management applications typically handle user interaction, health data analysis, and reminder management as separate and loosely coupled functions. A dialog engine may generate generic avatar reactions from user text, a separate analytics module may compute health indices from wearable sensor data, and a scheduler may trigger notifications at fixed times. In such architectures, the processor simply orchestrates independent modules without deeply integrating their respective outputs into a unified, adaptive control flow. As a result, several technical problems arise.

First, existing systems often fail to exploit the rich, heterogeneous data available at the processor, such as biometric measurement information, behavior information, schedule information, and user feedback, in a coordinated manner. Prompt sentences supplied to a generative AI model are typically handcrafted or static templates that do not systematically encode machine-computed indices (for example, health state indices or activity indices) and user-specific constraints. Consequently, the generative AI model is effectively used as a generic text generator, and the processor cannot reliably steer the model toward producing context-appropriate, safety-constrained outputs. This leads to low determinism in system behavior and inefficient use of computation and communication resources.

Second, conventional systems do not provide a structured feedback loop at the processor level that closes the gap between generated content and subsequent system behavior. Even when user evaluation information and response information are collected, such data are frequently stored as passive logs without being actively used to update prompt structures, operating conditions, or parameters of the generative AI model. Therefore, the processor cannot progressively adapt the model behavior and prompt configuration based on statistically aggregated feedback from multiple users. This lack of adaptive control limits the ability of the system to improve the effectiveness and relevance of generated advice and avatar responses over time.

Third, many prior systems treat the avatar display, the health advice generation, and the reminder notification as independent subsystems that are merely co-located on the same server or terminal device. The processor often fails to coordinate these subsystems using a unified representation of analysis result information and prompt sentences. For example, avatar reactions are not consistently synchronized with current health state indices and upcoming schedule information, and reminder notifications are triggered without reflecting the most recent generative AI outputs or user emotional state. This results in fragmented user experiences and increased complexity in application logic, as each function must implement its own partial interpretation of user state.

Fourth, from a computer-technology standpoint, there is no standardized processor-level mechanism to (i) transform structured sensor and schedule data into prompt sentences for a generative AI model, (ii) enforce expression style, length, and content constraints in those prompt sentences, and (iii) iteratively refine both the prompt structure and the generative AI model conditions using aggregated feedback. The absence of such a mechanism leads to systems that are harder to scale, harder to maintain, and less predictable in their computational behavior. In particular, the system cannot ensure that processing and storage resources are utilized efficiently to maximize the quality of generated outputs.

Accordingly, there is a need for a computer-implemented system in which the processor is specifically configured to integrate biometric measurement information, behavior information, schedule information, and user feedback into the generation and refinement of prompt sentences for a generative AI model; to generate individualized advice information and avatar response expression information based on analysis result information; and to update operation conditions of the generative AI model using aggregated statistical information. Such a system should improve the functioning of the computer itself by providing a structured, adaptive control loop between data acquisition, analysis, prompt construction, generative inference, user interaction, and model refinement, thereby increasing the determinism, efficiency, and scalability of the overall processing pipeline.

The specific processing by the specific processing unit 290 of the data processing device 12 in Example 2 is realized by the following means.

The present invention provides a server comprising a processor configured to parse a natural language prompt sentence acquired from a user, generate feature information by generating, based on the prompt sentence, a prompt sentence for input to a generative information processing model, generate display control information relating to an appearance and a personality of a visual representation entity based on the feature information, and transmit the display control information to a terminal device so as to cause the terminal device to display the visual representation entity; acquire biometric measurement information and behavior information of the user via a body information acquisition apparatus and the terminal device, and store the biometric measurement information and the behavior information; execute information processing on the stored biometric measurement information and behavior information to calculate a health state index and an activity index of the user, and generate analysis result information; generate, based on the analysis result information and the natural language prompt sentence acquired from the user, a health management and daily living behavior prompt sentence for input to the generative information processing model, the health management and daily living behavior prompt sentence including attribute information representing at least the health state index, the activity index, schedule information, and behavior goal information of the user, and instruction information relating to an expression style, a length, and content constraints of advice information; cause the generative information processing model to generate the advice information in accordance with the health management and daily living behavior prompt sentence; generate response expression information of the visual representation entity according to a health state and an emotional state of the user based on the advice information, and notify the user via the terminal device; store the schedule information and the behavior goal information acquired from the user, generate notification information based on the schedule information and the behavior goal information, and cause the terminal device to execute reminder notification based on the notification information; acquire evaluation information or response information from the user regarding the advice information and the notification information; aggregate the evaluation information and the response information collected from a plurality of users to generate statistical information; and update configuration elements of the prompt sentence for input to the generative information processing model and operation conditions of the generative information processing model, including at least training data or weight parameters, based on the statistical information. This enables the computer system to more effectively utilize heterogeneous user data to construct structured and constrained prompt sentences, to generate individualized advice information and synchronized avatar responses using the generative information processing model, and to adaptively refine both the prompt configuration and model operation conditions in response to aggregated user feedback, thereby improving the overall processing efficiency, consistency, and predictive behavior of the system.

The term “processor” refers to one or more hardware-based information processing units, such as a central processing unit or dedicated processing circuitry, configured to execute instructions and perform data processing operations to implement functions of the system.

The term “natural language prompt sentence” refers to a text string expressed in a human language, received from a user or generated by the system, that describes a request, condition, or context to be used for controlling subsequent information processing.

The term “generative information processing model” refers to a machine learning model, such as a neural network or language model, configured to generate output information including text or other content in response to an input prompt sentence.

The term “feature information” refers to data representing one or more attributes extracted or derived from a natural language prompt sentence, including parameters or descriptors used to control appearance, personality, or behavior of a visual representation entity or to construct a prompt sentence for a generative information processing model.

The term “visual representation entity” refers to a computer-generated graphical representation, such as an avatar or character image, displayed on a terminal device and used as an interface element for interaction with a user.

The term “display control information” refers to data specifying at least one of an appearance, a personality, a behavior, or a state of a visual representation entity, the data being used to control rendering or animation of the visual representation entity on a terminal device.

The term “terminal device” refers to an information processing apparatus operated by a user, such as a mobile communication device, a portable computing device, or a desktop computing device, that communicates with the server and presents information to the user.

The term “body information acquisition apparatus” refers to an electronic measurement apparatus, such as a wearable sensor device or health monitoring device, configured to measure biometric data of a user and to provide the biometric data to the server via a terminal device or communication network.

The term “biometric measurement information” refers to time-series or discrete data representing physiological states of a user, including at least one of heart rate data, movement data, step count data, temperature data, or other measurable bodily parameters.

The term “behavior information” refers to data representing user actions or activities, including at least one of movement patterns, exercise habits, daily routines, application usage patterns, or interactions with reminder notifications.

The term “health state index” refers to one or more numerical or categorical indicators calculated from biometric measurement information and behavior information to represent a health-related state of a user, such as activity level, cardiovascular load, or fatigue level.

The term “activity index” refers to one or more numerical or categorical indicators derived from user activity data, such as step counts or movement duration, representing a degree of physical activity of a user during a predetermined period.

The term “analysis result information” refers to data produced by information processing performed on biometric measurement information and behavior information, including at least health state indices, activity indices, detected anomalies, and summarized interpretations of a user's condition.

The term “health management and daily living behavior prompt sentence” refers to a prompt sentence generated by the processor for input to a generative information processing model, the prompt sentence describing a user's health state, activities, schedules, and behavior goals and requesting generation of advice related to health management or daily living behavior.

The term “attribute information” refers to structured data elements embedded in or associated with a prompt sentence, representing one or more user-specific parameters, including at least a health state index, an activity index, schedule information, or behavior goal information.

The term “instruction information” refers to control data included in or associated with a prompt sentence, indicating constraints or preferences regarding an expression style, a length, or content limitations of advice information to be generated by the generative information processing model.

The term “advice information” refers to output information generated by the generative information processing model in response to a prompt sentence, including recommendations, guidance, or suggestions related to user health management or daily living behavior.

The term “response expression information” refers to data defining how a visual representation entity should express a reaction, including changes in appearance, gestures, or messages, based on at least a health state, an emotional state, or advice information relating to a user.

The term “schedule information” refers to data representing time-related entries associated with a user, including appointments, planned activities, medication times, or other events for which notifications or reminders are to be provided.

The term “behavior goal information” refers to data representing target values or desired objectives related to user behavior, such as activity targets, exercise goals, or lifestyle improvement goals.

The term “notification information” refers to data specifying content, timing, and conditions of a reminder or alert to be output by a terminal device, based on at least schedule information or behavior goal information.

The term “reminder notification” refers to a presentation of information to a user by a terminal device at a predetermined or condition-based time, including visual, auditory, or haptic output to prompt the user to perform a scheduled action or task.

The term “evaluation information” refers to data provided by a user indicating a degree of satisfaction, usefulness, or appropriateness of advice information or notification information, including ratings, binary responses, or free-text comments.

The term “response information” refers to data representing a user's reaction or behavior in response to advice information or notification information, including at least user selections, confirmation operations, postponement operations, or compliance records.

The term “statistical information” refers to aggregated data computed from evaluation information and response information collected from one or more users, including averages, distributions, correlations, or other statistics used to analyze performance of advice information or prompt configurations.

The term “operating conditions of the generative information processing model” refers to parameters or settings that influence execution of the generative information processing model, including at least model selection, control parameters, training data sets, or weight parameters.

In one embodiment, a server, a terminal, and a body information acquisition apparatus cooperate to implement the claimed system. The server comprises at least one hardware processor, a memory, and a network interface. The terminal comprises an input/output unit, a display, a speaker, and a communication module such as a wireless communication module. The body information acquisition apparatus comprises at least one biometric sensor, such as a heart rate sensor or an accelerometer, and a wireless interface such as a short-range radio communication interface.

The server stores instructions and data structures in the memory. The server loads the instructions into the processor to implement multiple logical modules, including a user interface management module, a data acquisition module, an analysis module, a prompt generation module, a generative AI model interface module, an avatar control module, a reminder management module, and a feedback analysis module. The server implements these modules using general-purpose software frameworks such as an operating system, a web server, and an application framework. For example, the server uses a general-purpose operating system such as a UNIX-compatible operating system, a web server such as an HTTP server, and an application layer implemented by a web application framework such as a Python-based framework or a similar platform. The server stores biometric measurement information, behavior information, schedule information, analysis result information, advice information, evaluation information, and model configuration information in a structured data store such as a relational database management system.

The terminal implements a native application program on a portable information processing device. The terminal uses an operating system such as a mobile operating system, a local database such as a structured query engine, and platform-specific user interface components. The terminal also uses communication libraries for secure protocol communication, an audio output subsystem for text-to-speech synthesis, and a graphics subsystem for rendering a visual representation entity, such as an avatar.

The body information acquisition apparatus is realized as a wearable device or health monitoring device that measures biometric parameters such as heart rate, step count, or body temperature. The body information acquisition apparatus uses specialized sensor hardware such as photoplethysmography sensors and motion sensors, a local microcontroller, and a short-range wireless communication module such as a low-energy radio communication module. The body information acquisition apparatus transmits raw or preprocessed biometric data to the terminal under control of dedicated firmware.

The server generates a program, in the sense that the server stores and executes computer-readable instructions that implement the above logical modules and data flows. The server configures data structures such as tables and indices in the database. For example, the server defines a record structure for biometric measurement information, including fields for a user identifier, a timestamp, a measurement type, and a measurement value. The server defines structures for behavior information, analysis result information, schedule information, and advice information. The server uses index structures on key fields such as the user identifier and the timestamp to enable efficient range retrievals when the analysis module computes health state indices and activity indices.

The server implements the generative AI model as a generative information processing model, for example as a transformer-based neural network specialized as a generative language model. The server deploys this model either locally, using a machine learning framework such as a numerical computation library with an automatic differentiation engine, or remotely via a dedicated generative AI service. The model comprises a multi-layer architecture including an embedding layer, multiple self-attention layers, feed-forward layers, and a token generation output layer. The server initializes the model with parameters obtained from prior training on generic language data and optionally fine-tunes the model using domain-specific pairs of prompt sentences and advice texts that have been rated positively by users.

The server configures the training process of the generative AI model using a loss function such as cross-entropy error between predicted token distributions and ground-truth tokens. The server updates weight parameters of the model by gradient-based optimization algorithms such as stochastic gradient descent or adaptive gradient methods. The server optionally uses regularization techniques such as dropout and weight decay and uses data augmentation techniques such as paraphrasing or controlled template expansion for training text. By storing and applying these training and update routines at the server, the system provides concrete machine-level operations that modify the internal state of the generative AI model in response to aggregated evaluation information.

The server, when executing the analysis module, performs concrete data processing operations on biometric measurement information and behavior information. The server loads time-series heart rate values and step counts for a given day into an in-memory data structure such as a columnar data table. The server computes a resting heart rate estimate by first selecting time windows where movement magnitude is below a threshold, then averaging heart rate values in these windows. The server computes an activity index by aggregating step counts per time interval and mapping total daily steps to discrete categories such as “low,” “medium,” or “high” based on predefined thresholds stored in configuration data. The server computes additional features, such as the standard deviation of heart rate values or the ratio between active and inactive periods. These numerical operations use vectorized methods in a numerical library or equivalent routines, which reduce processing time compared to naive scalar loops and therefore improve processing efficiency and responsiveness.

The server, when executing the prompt generation module, maps these analysis results into structured prompt sentences. The server uses a prompt template stored as a text pattern with placeholders for analysis result fields and user attributes. For example, the server constructs a health management and daily living behavior prompt sentence such as:
“The user's average resting heart rate today is 96 bpm, which is higher than the user's usual resting heart rate of 78 bpm. The user's total steps today are 3,400, which is below the daily goal of 8,000 steps. The user has no major chronic conditions recorded. Please generate short, practical, and safe exercise and lifestyle advice focusing on light activities, stress reduction, and gradual improvement. Avoid giving any strict medical diagnoses.”

The server also constructs shorter prompt sentences such as:
“Please generate exercise advice for a user whose heart rate is high.”

The server embeds attribute information and instruction information into these prompt sentences. The attribute information explicitly encodes the computed health state index and activity index in textual form, while the instruction information encodes constraints such as “use simple language,” “limit the response to three sentences,” or “avoid sensitive medical terms.” The server may store these constraints as structured metadata and then map them into textual phrases inside the prompt sentence. This explicit structure enables the processor to systematically control the generative AI model output, rather than relying on ad hoc free-form natural language instructions.

The server, when executing the generative AI model interface module, converts each prompt sentence into a token sequence using a tokenizer associated with the model configuration. The server sets model operation conditions such as maximum token count, temperature, and top-k or top-p sampling parameters based on configuration data or runtime feedback. The server then executes the generative AI model to compute probability distributions over tokens at each decoding step and selects output tokens according to the configured sampling strategy. This concrete sequence of numerical computations within the neural network, including matrix multiplications and attention operations, yields the advice information as a text string.

The server, when executing the avatar control module, generates display control information that links advice information, the health state index, and user emotional state indicators to visual attributes of the avatar. The server stores mapping rules that associate specific ranges of indices and feedback signals with avatar facial expressions, posture, or color schemes. For example, when the health state index indicates elevated stress and the advice recommends rest, the server sets parameters indicating a calm facial expression, slow animation speed, and a soothing color palette. The server transmits this display control information to the terminal. The terminal applies these parameters to a 2D or 3D rendering engine to update the avatar's appearance and scripted behavior, thereby reflecting internal system decisions in a perceivable graphical form on the user's device.

The terminal collects biometric measurement information and behavior information by receiving data from the body information acquisition apparatus over a short-range wireless interface and by logging user interactions and usage patterns. The terminal preprocesses these data by converting hardware-specific measurement packets into a standardized format with units, timestamps, and measurement identifiers. The terminal may compress or batch these records to reduce communication load before transmitting them to the server over a network using a secure communication protocol. By aggregating and compressing data on the terminal, the system reduces network overhead and improves overall communication efficiency.

The terminal presents advice information and avatar responses to the user. The terminal renders the visual representation entity on a display according to the display control information received from the server. The terminal converts advice information into speech using a text-to-speech engine integrated within the operating system and outputs the speech through a speaker. The terminal also displays textual advice and interactive elements that allow the user to provide evaluation information, such as rating the advice as useful or not useful, or entering free-form comments.

The server, when executing the reminder management module, stores schedule information and behavior goal information in the database and computes notification times and patterns. The server generates notification information that includes a notification type, a time or time window, and content text. The server transmits this notification information to the terminal. The terminal registers local reminder notifications with the operating system scheduler. This configuration allows reminders to be displayed at precise times even when the application is in the background or connectivity is unstable. The integration of schedule information with generated advice information allows the server to synchronize advice timing with planned activities, which improves adherence and user engagement.

The user interacts with the system by inputting prompt sentences, schedule entries, and feedback through the terminal. The user submits natural language prompt sentences for avatar customization and advice requests. For example, the user enters:
“I would like my avatar to look friendly and energetic and to encourage me to walk more.”

The terminal transmits this prompt sentence to the server. The server parses this prompt sentence using natural language processing routines implemented as rule-based parsers or classification models, extracts feature information such as desired avatar personality attributes and motivational tone, and updates display control information and prompt templates accordingly.

The server, when executing the feedback analysis module, collects evaluation information and response information from the database, groups them by prompt template pattern, model configuration, and advice type, and computes statistical metrics such as average rating and adherence probability. The server identifies patterns where certain prompt configurations result in consistently higher ratings or higher compliance with behavior goals. The server adjusts the prompt templates by modifying or reordering constraint phrases, and adjusts model operating conditions by tuning sampling parameters or by selecting model variants that yield higher-rated outputs. The server also uses highly rated prompt-advice pairs as additional training samples to fine-tune the generative AI model. The server computes loss values on these samples and performs incremental weight updates, thereby shifting the model's output distribution towards content that users consistently evaluate as more appropriate or helpful. This adaptive update process is not a mere automation of a human task but a technical improvement to the functioning of the computer system. By encoding computed indices and constraints into the prompt sentence structure and by incorporating statistical feedback into both prompt design and model parameter optimization, the server increases the predictability and relevance of model outputs. As a result, the server reduces the number of iterations and network calls required to obtain a satisfactory piece of advice, lowering computational and communication load. Furthermore, by using efficient vectorized numerical operations and optimized index structures, the server reduces processing time for analysis tasks, enabling near-real-time responsiveness even when handling large volumes of biometric data.

In another embodiment, the server executes a different generative AI model architecture, such as an encoder-decoder model or a mixture-of-experts language model. The server still constructs prompt sentences including attribute information and instruction information, but the server changes the internal model configuration, such as the number of layers, hidden size, and attention heads, to match hardware capabilities. The server may allocate parts of the model across multiple computing nodes and manage distributed inference. In yet another variation, the server employs a smaller, on-device generative AI model running on the terminal for low-latency personalization, while a larger server-side model handles more complex advice generation. In this case, the server transmits distilled prompt sentences and advice summaries to the terminal, and the terminal refines the content using the local model based on locally stored context.

In a further embodiment, the server uses an additional rule-based module that monitors generated advice information and applies deterministic filters to ensure compliance with safety constraints. The server uses pattern-matching rules and lexical analysis to detect prohibited phrases and replaces or removes them. This non-neural module operates in tandem with the generative AI model and provides an additional layer of control and reliability at the processor level.

In all embodiments, the integration of data analysis, structured prompt construction, generative AI model execution, avatar control, and feedback-driven adaptation within the server's processing pipeline yields specific technical effects. The server reduces redundant computations by reusing computed indices across multiple modules, improves storage efficiency by using normalized schemas for different information types, and improves user-level response quality in a computationally controlled manner. This coordinated, multi-stage processing pipeline, realized by concrete hardware and software components and by specific data structures and algorithms, constitutes a technical implementation that goes beyond an abstract idea or a mere automation of human advisory tasks.

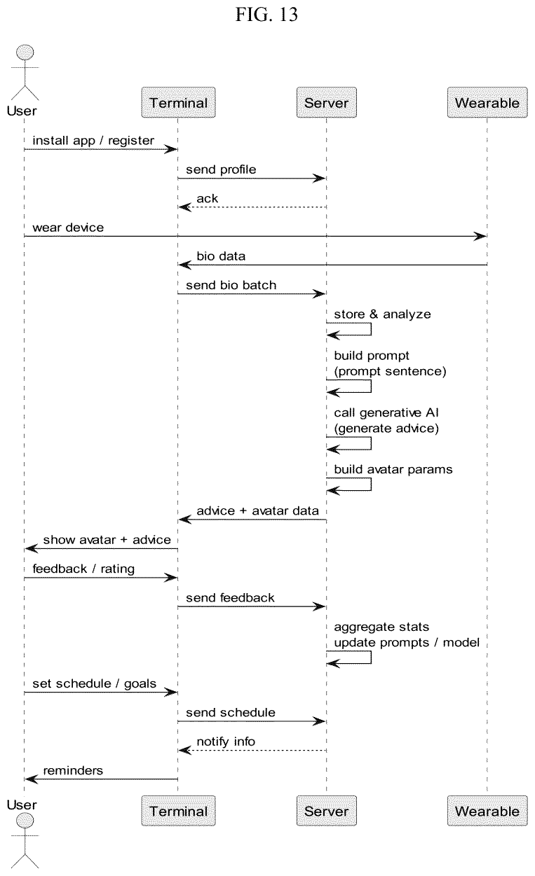

The following describes the processing flow using FIG. 13.

### Step 1

The user installs an application on the terminal and creates an account by entering profile information such as age, gender, and general activity level. The input is user-entered profile data. The output is a structured profile record stored on the terminal. The terminal converts the profile data into a structured format with fields and data types, and then transmits this profile record to the server using a secure communication protocol.

### Step 2

The server receives the profile record from the terminal and validates the contents, including format checking and range checking of age and other attributes. The input is the structured profile record received from the terminal. The output is a normalized user profile entry stored in a database and an assigned user identifier. The server parses the received data, assigns a unique identifier, and inserts the normalized fields into a relational table with indices on the user identifier.

### Step 3

The user pairs a body information acquisition apparatus, such as a wearable sensor device, with the terminal and begins ordinary daily activities. The input is sensor measurements inside the body information acquisition apparatus. The output is low-level biometric measurement packets sent to the terminal via short-range wireless communication. The body information acquisition apparatus collects raw sensor signals, performs local filtering or averaging, and encapsulates measurement values with timestamps into packets following a defined protocol.

### Step 4

The terminal acquires the biometric measurement packets from the body information acquisition apparatus and converts them into a unified internal representation. The input is device-specific measurement packets. The output is standardized biometric measurement information records. The terminal decodes each packet, extracts parameters such as heart rate and step count, converts units if necessary, attaches the user identifier and absolute timestamps, and stores these records temporarily in a local buffer.

### Step 5

The terminal aggregates multiple biometric measurement records over a defined time window and prepares a transmission batch. The input is a sequence of biometric measurement records in the local buffer. The output is an aggregated batch formatted as a compact data structure for network transfer. The terminal groups records by user identifier and time, compresses the grouped data if a compression algorithm is used, and assembles the aggregated data into a single message for transmission to the server.

### Step 6

The server receives the aggregated biometric measurement batch from the terminal and performs validation and normalization. The input is the aggregated batch message. The output is a set of validated biometric measurement entries stored in database tables. The server decomposes the batch into individual records, checks timestamp consistency, filters out implausible values based on preset thresholds, converts time zones to a standard reference, and inserts the cleaned records into relational tables with indices on the user identifier and timestamp columns.

### Step 7

The server retrieves recent biometric measurement information and behavior information for each user from the database to prepare for analysis. The input is a query specifying a user identifier and a time range. The output is a time-series dataset of measurements and behavior events loaded into memory. The server executes database queries, loads the results into an in-memory data structure such as a table or matrix, and orders records chronologically to enable subsequent numerical processing.

### Step 8

The server computes health state indices and activity indices based on the time-series dataset. The input is the in-memory dataset of biometric measurement information and behavior information. The output is a set of derived indices, such as average resting heart rate and total daily steps. The server selects intervals with low motion readings to estimate resting periods, computes mean and variance of heart rate in those intervals, sums step counts over predefined time windows, and maps totals to categorical levels using stored threshold values, thereby performing arithmetic aggregation and threshold-based classification.

### Step 9

The server generates analysis result information by summarizing the computed indices and detected patterns. The input is the set of derived health state indices and activity indices. The output is a structured analysis result object. The server combines numeric indices with categorical flags indicating anomalies, attaches metadata such as analysis date and user identifier, and stores this analysis result object in an analysis table in the database for later retrieval and reuse.

### Step 10

The server constructs a health management and daily living behavior prompt sentence for the generative AI model using the analysis result information and stored user profile data. The input is the analysis result object and the normalized user profile. The output is a fully instantiated prompt sentence containing attribute information and instruction information. The server replaces placeholder tokens in a predefined template with actual index values and user attributes, appends constraint phrases specifying expression style and length, and concatenates the elements into a coherent natural-language string.

### Step 11

The server transmits the constructed prompt sentence to the generative AI model and requests generation of advice information. The input is the prompt sentence and model configuration parameters such as maximum token count and sampling temperature. The output is a generated text response representing advice information. The server encodes the prompt sentence into tokens, passes the tokens and parameters to a transformer-based generative AI model, and executes the model's forward pass to compute token probabilities and decode a sequence of output tokens, which the server then converts back into text.

### Step 12

The server post-processes the generated advice information to enforce constraints and remove undesired content. The input is the raw advice text generated by the generative AI model. The output is filtered advice information suitable for user presentation. The server scans the text using rule-based filters and pattern-matching functions, removes or replaces prohibited terms, truncates the text if it exceeds the desired length, and marks segments for emphasis or formatting that will later be translated into display attributes.

### Step 13

The server generates response expression information for a visual representation entity based on the filtered advice information and the health state index. The input is the filtered advice information and the computed indices. The output is a set of avatar control parameters. The server applies mapping rules that associate ranges of indices and advice types with avatar facial expressions, gesture profiles, and animation speeds, and encodes these selections as display control information that includes identifiers for expression presets and timing parameters.

### Step 14

The server transmits the advice information and the display control information to the terminal. The input is a combined message that includes advice text and avatar control parameters. The output is a network response received by the terminal. The server packages the information into a structured payload, attaches the user identifier and message identifier, and sends the payload over the network via a secure protocol to the terminal.

### Step 15

The terminal receives the advice information and display control information from the server and updates the user interface. The input is the payload containing advice text and avatar parameters. The output is a visual and auditory presentation on the terminal. The terminal parses the payload, applies the avatar parameters to a graphics engine to change the avatar's appearance and animation, renders the advice text in a text view, and optionally invokes a text-to-speech engine to output the advice as synthesized speech through a speaker.

### Step 16

The user views or listens to the advice information and interacts with the avatar. The input is the displayed advice and avatar behavior on the terminal. The output is user actions such as reading, tapping, or speaking back to the terminal. The user may confirm understanding, dismiss the message, or navigate to a feedback screen. The terminal records these interactions as behavior information with timestamps and action types.

### Step 17

The user inputs evaluation information regarding the advice information and any reminder notifications. The input is user selections such as ratings, categorical responses, or free-text comments entered on the terminal. The output is structured evaluation information records. The terminal converts each rating or comment into a standardized representation including an advice identifier, a score value, and optional text, and stores it in a local buffer for transmission to the server.

### Step 18

The terminal transmits the evaluation information and response information to the server. The input is the buffered feedback records. The output is received feedback data on the server. The terminal batches multiple feedback records, serializes them into a compact format, and sends them via a secure network request to the server, reducing overhead by grouping small interactions into fewer transmissions.

### Step 19

The server stores and organizes the evaluation information and response information in feedback-related tables. The input is the feedback records received from the terminal. The output is persistent feedback entries linked to advice identifiers and user identifiers. The server validates each record, checks for missing fields, associates each feedback entry with the corresponding advice and analysis result, and inserts the records into normalized database tables with appropriate indices to support subsequent aggregation.

### Step 20

The server aggregates feedback from multiple users to generate statistical information for analysis. The input is a collection of feedback entries over a defined time interval. The output is aggregated metrics such as mean ratings per prompt template and compliance rates per advice type. The server executes group-by queries or equivalent aggregation routines to compute averages, counts, and distributions, and stores the aggregated results as statistical information objects for use in model and prompt adjustment.

### Step 21

The server updates configuration elements of the prompt sentence based on the statistical information. The input is the statistical information related to ratings and response behaviors. The output is revised prompt templates and constraint configurations. The server identifies prompt patterns associated with higher ratings, modifies template text to emphasize effective phrases, adjusts instruction information regarding length and specificity, and saves updated templates and constraints in configuration storage.

### Step 22

The server adjusts operation conditions of the generative AI model using the statistical information and selected high-quality examples. The input is the statistical information and a subset of highly rated prompt-advice pairs. The output is updated model parameters or model selection settings. The server constructs a fine-tuning dataset from these pairs, computes gradients of a loss function such as cross-entropy with respect to model parameters, performs parameter updates using an optimization algorithm, and optionally adjusts inference parameters such as temperature or decoding strategy to favor more reliable outputs.

### Step 23

The server generates schedule information and behavior goal information for reminder notifications, or receives such information from the terminal and stores it. The input is user-defined or system-suggested schedule entries and goals. The output is normalized schedule and goal records stored in the database. The server parses time expressions and recurrence rules, validates time zones, and stores each reminder or goal with associated user identifiers and target values.

### Step 24

The server produces notification information from schedule information and behavior goal information and transmits it to the terminal. The input is schedule and goal records with timing details. The output is notification definitions ready for local registration by the terminal. The server computes trigger times or conditions, composes notification messages, and sends the resulting notification information to the terminal in a structured format.

### Step 25

The terminal registers reminder notifications with an operating system scheduler and later displays them to the user at specified times. The input is the notification information received from the server. The output is scheduled notifications and user-visible alerts. The terminal calls system-level APIs to register each notification with timing and content parameters, and at trigger time, the terminal displays an alert message such as “It is time to take your medicine” or “Please start your planned walk,” optionally playing a sound or vibration.

### Step 26

The user responds to reminder notifications and potentially updates behavior information. The input is the reminder alert on the terminal. The output is user actions such as marking completion or postponement of a task. The terminal records these actions with timestamps and associates them with corresponding schedule entries and behavior goals, generating new behavior information records that indicate adherence or non-adherence.

### Step 27

The server incorporates the updated behavior information and feedback into future analyses and advice generation. The input is new biometric measurement information, behavior information, evaluation information, and response information accumulated over time. The output is updated analysis result information, refined prompt sentences, and improved advice information generated in subsequent cycles. The server re-executes the analysis, prompt generation, and generative AI model steps with the enriched data, thereby closing the loop and continuously adapting the system to user-specific patterns and aggregate statistical trends.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional avatar-based user interfaces and assistance systems generally treat avatars as static presentation layers that merely display pre-authored content or simple rule-based responses. In such systems, a processor typically separates low-level sensor processing, high-level content generation, and avatar control, resulting in fragmented pipelines that are not optimized as an integrated computer-implemented architecture. For example, existing systems often (i) do not structurally integrate time-series biometric data, behavior data, and multi-modal emotion data into a unified representation that can drive avatar behavior, (ii) do not leverage generative AI models through well-structured prompt sentences that encode system state, user state, and desired outcomes in a machine-optimized manner, and (iii) rely on fixed scripts or hand-crafted rules that limit scalability and make it difficult to adapt to different users or use cases without extensive manual re-programming.

Furthermore, conventional systems typically perform only superficial sentiment classification on user text or voice, without combining such sentiment with physiological data, behavioral patterns, and lifestyle information in a way that meaningfully alters the computational workflow of the avatar engine. As a result, the computing system fails to deliver context-aware, adaptive responses that optimize the use of computational resources and model capabilities. The underlying computer technology—namely, the way processors structure, transform, and route data to machine-learning models—remains inefficient, with repeated ad-hoc calls to models, redundant pre- and post-processing, and limited reuse of learned state across interactions.

In addition, existing architectures for generative AI integration often expose the generative model as a generic text-in/text-out component, leaving the application logic to manually construct unstructured prompts. This leads to non-deterministic behavior, difficulty in testing and maintaining the system, and suboptimal utilization of model capacity, since important context such as emotion state, health state, and avatar feature data is not encoded in a systematic, machine-friendly prompt structure. The lack of a unified processor that performs (a) structured acquisition and preprocessing of heterogeneous user data, (b) state estimation for emotion and health, (c) dynamic construction of prompt sentences that integrate these states with avatar feature data, and (d) coordinated control of avatar image generation and motion, results in reduced robustness, increased latency, and limited personalization.

Accordingly, there is a need for a computer-implemented system in which a processor is specifically configured to (1) treat prompt sentences as structured control messages that encode multi-modal user state and avatar state, (2) generate, update, and reuse feature data representing appearance attributes and personality attributes of a virtual display object, (3) integrate emotion estimation and health or behavior evaluation into the generative pipeline, and (4) orchestrate generative AI models and rendering components in a coordinated manner. Such a system should improve the way the computer processes and routes data to machine-learning components, thereby enhancing adaptability, reducing redundant processing, and enabling more efficient and consistent avatar-based interaction.

The specific processing by the specific processing unit 290 of the data processing device 12 in Application Example 2 is realized by the following means.

The present invention provides a server comprising a processor configured to parse prompt sentences received from a user, generate structured feature data representing appearance attributes and personality attributes of a virtual display object based on the parsed content, and output control information including further prompt sentences that cause a generation processing apparatus to perform image generation or motion control for the virtual display object on the basis of the feature data; to analyze voice information, image information, and character information acquired from the user to estimate an emotion state of the user, and to store biometric information and behavior information acquired from the user as time-series data, preprocess the time-series data to generate feature quantity data, and evaluate a health state or a behavior state of the user from the feature quantity data; and to construct prompt sentences that encode at least the estimated emotion state, the evaluated health state or behavior state, and the feature data, supply the prompt sentences to at least one generative AI model to generate response messages, response action information, and support messages including at least one of break proposals, exercise proposals, lifestyle improvement proposals, and product proposals, and transmit the generated messages and action information to a user terminal so that the virtual display object presents the messages and corresponding motions to the user. This enables the computer system to integrate multi-modal user data into a unified, machine-optimized control flow, to systematically construct and utilize prompt sentences as internal control artifacts driving generative AI models, and to dynamically adapt avatar behavior and support content in a way that improves the efficiency, consistency, and personalization of avatar-based human-computer interaction.

The term “processor” refers to a hardware-implemented computation unit, such as a central processing unit, microprocessor, or processing circuitry, that executes instructions to perform data processing, analysis, and control operations in the system.

The term “user” refers to a human operator who interacts with the system by providing input, such as prompt sentences, voice, images, or biometric data, and who receives output, such as messages or visual presentations from a virtual display object.

The term “prompt sentence” refers to a sequence of natural language characters or tokens that encodes instructions, context, or requests, and that is used as input to a generative AI model or to internal parsing logic to control generation of feature data, messages, or actions.

The term “feature data” refers to structured data representing attributes or characteristics of a virtual display object, including at least appearance attributes and personality attributes, which are generated by parsing one or more prompt sentences and are used to control image generation and behavior of the virtual display object.

The term “appearance attribute” refers to an attribute describing a visual characteristic of a virtual display object, including but not limited to body type, color, clothing style, facial features, or other graphical elements used in rendering.

The term “personality attribute” refers to an attribute describing a behavioral or psychological characteristic of a virtual display object, including but not limited to friendliness, talkativeness, energy level, empathy level, or typical speaking style.

The term “virtual display object” refers to a computer-generated graphical entity, such as an avatar or digital character, that is visually presented on a display device and that serves as an interface element for interaction with the user.

The term “generation processing apparatus” refers to a hardware and software combination, separate from or integrated with the processor, that executes generative algorithms to produce image data, motion data, or other content based on control information and prompt sentences.

The term “image data” refers to digital data representing a still or moving visual representation, such as a bitmap, vector graphic, or rendered frame sequence, that is used to display the virtual display object.

The term “motion data” refers to digital data representing temporal changes in pose, position, animation parameters, or skeletal transformations of a virtual display object, which are used to control movements and gestures of the virtual display object.

The term “user terminal” refers to an electronic device operated by the user, such as a mobile device, wearable device, personal computer, or head-mounted display, that includes at least one display and communication interface for receiving data from the server and presenting the virtual display object or messages.

The term “voice information” refers to audio data acquired from the user, including spoken utterances or other vocal sounds, which are used for speech recognition, emotion estimation, or interaction control.

The term “image information” refers to visual data acquired from a sensor, such as a camera image or video frame including the user's face or body, which is used for emotion estimation, identity association, or behavioral analysis.

The term “character information” refers to textual data, such as typed text or recognized speech transcripts, obtained from the user and processed by the system for intent understanding, sentiment analysis, or prompt parsing.

The term “emotion state” refers to a representation of a current psychological condition of the user, such as joy, sadness, stress, anger, or calmness, optionally including an intensity value, estimated from at least one of voice information, image information, and character information.

The term “biometric information” refers to measurable physiological or biological data of the user, including but not limited to heart rate, respiration rate, movement signals, or other body-related signals acquired by a sensor.

The term “behavior information” refers to data describing actions or activities of the user over time, including but not limited to posture, physical activity level, work duration, or interaction patterns with the system.

The term “time-series data” refers to data comprising multiple samples of biometric information or behavior information associated with ordered time points, which are stored and processed as chronological sequences.

The term “feature quantity data” refers to numerical or symbolic values derived from time-series data by preprocessing operations, such as filtering, aggregation, or transformation, that are used as input to evaluation or estimation logic.

The term “health state” refers to an evaluation result indicating a physical or physiological condition of the user, such as normal, elevated load, fatigue, or stress-related state, inferred from feature quantity data.

The term “behavior state” refers to an evaluation result indicating a behavioral or activity pattern of the user, such as prolonged static posture, high activity, low activity, or irregular routine, inferred from feature quantity data.

The term “support content” refers to information intended to assist or guide the user, including at least one of a break proposal, an exercise proposal, a lifestyle improvement proposal, and a product proposal, generated on the basis of user state.

The term “break proposal” refers to support content recommending that the user temporarily stop ongoing activity or work, such as standing up, resting, or hydrating, to improve health or comfort.

The term “exercise proposal” refers to support content recommending that the user perform physical movement, such as stretching or walking, to promote physical well-being or alleviate strain.

The term “lifestyle improvement proposal” refers to support content recommending modifications of long-term habits or routines, such as sleep schedule, activity pattern, or diet-related behavior, to improve overall health or quality of life.

The term “product proposal” refers to support content recommending one or more goods or services that may address a detected user need or state, such as relaxation items, health-related items, or other consumables.

The term “generative AI model” refers to a trained machine learning model configured to produce new outputs, such as text, images, or control signals, in response to prompt sentences, based on patterns learned from training data.

The term “response message” refers to natural language text generated by the generative AI model in response to a prompt sentence, which is intended to be presented to the user via the virtual display object.

The term “response action information” refers to control data generated by the generative AI model or derived from its outputs, specifying how the virtual display object should act, including gestures, expressions, or motion patterns.

The term “support message” refers to a response message that contains at least one of a break proposal, an exercise proposal, a lifestyle improvement proposal, or a product proposal, and that is intended to assist the user.

The term “control information” refers to data output from the processor, including prompt sentences, parameters, and identifiers, that instructs a generation processing apparatus or a user terminal to perform image generation, motion control, or presentation of content.

The term “natural language processing technique” refers to a software-implemented procedure that analyzes and interprets human language text to extract structure, meaning, or intent, including tokenization, parsing, entity extraction, and semantic analysis.

The term “utterance content” refers to semantic information contained in spoken or textual communication from or through the virtual display object, including wording, style, and tone of generated dialogue.

The term “facial expression” refers to a configuration or animation state of the facial region of the virtual display object, such as smiling, frowning, or neutral, which is used to visually convey emotion or attitude.

The term “posture” refers to a spatial configuration or pose of the body of the virtual display object, including orientation and relative joint positions, as used in static or animated representations.

The term “motion pattern” refers to a temporal sequence of postures, gestures, or movements of the virtual display object, such as walking, waving, or nodding, which is used to express behavior or emphasis.

The term “lifestyle information” refers to data describing recurring habits or routines of the user, including patterns of sleep, physical activity, work schedules, or other daily behaviors collected over time.

The term “emotion alleviation” refers to a system objective of reducing intensity of negative emotion states of the user, such as sadness or stress, by generating and presenting appropriate responses or support content.

The term “motivation” refers to a system objective of increasing a user's willingness or intention to perform beneficial actions, such as exercise, rest, or adherence to healthy habits, through generated dialogue or support content.

The term “purchase support” refers to a system objective of assisting the user in selecting or deciding on products or services, by generating informative, context-aware product proposals and explanations via the virtual display object.

In one embodiment, a server implements the claimed system by executing software modules on a hardware platform including at least one central processing unit (CPU), a main memory, a non-volatile storage device, a network interface, and optionally at least one graphics processing unit (GPU) configured for accelerated numerical computation. The server runs an operating system, such as a general-purpose server operating system, and middleware including a web application framework (for example, a framework comparable to Flask), a database management system (for example, a system comparable to PostgreSQL or MySQL), and machine learning libraries (for example, libraries comparable to TensorFlow, NumPy, pandas, and scikit-learn).

The server stores program modules including at least a prompt parsing module, a feature data generation module, an emotion estimation module, a health and behavior evaluation module, a prompt construction module, a generative AI interface module, and a presentation control module. The server cooperates with at least one user terminal and at least one generation processing apparatus. The generation processing apparatus may be realized as a dedicated image and motion generation service executing on a GPU-equipped machine or as a cloud-based generative image/animation service. The user terminal may be realized as a mobile communication terminal, a wearable device, or a head-mounted display, each including a display, a processor, a memory, a microphone, a camera, and one or more sensors or interfaces to external sensors.

In one embodiment, the server implements the prompt parsing module as a combination of a natural language tokenizer, a syntactic parser, and a semantic role labeler using a natural language processing toolkit (for example, a toolkit comparable to spaCy or a cloud natural language API). The server stores prompt sentences received from the user as records in a prompt table in the database, each record including at least a user identifier, a timestamp, the raw prompt text, and parsing results. The server represents parsing results as a structured data object including token sequences, part-of-speech tags, dependency relations, and extracted attribute-value pairs. For instance, if the user inputs the prompt sentence:
“I like dogs. Please create a dog-like avatar that talks a lot and is very friendly.”
the server assigns tokens to each word, computes dependencies, and extracts attributes such as “appearance.animal_type=dog-like”, “personality.talkativeness=high”, and “personality.friendliness=high.” The server stores these attributes in a feature data structure, for example as a key-value map or as a fixed-length vector of normalized numeric values representing appearance and personality attributes.

The server generates feature data by combining extracted attributes with default profiles and normalization rules. The server uses a feature data generation module to map symbolic attributes to numeric parameters. For example, the server maps “dog-like” into a categorical index used by the generation processing apparatus, maps “very friendly” into a high value on a friendliness dimension in a [0,1] range, and maps “talks a lot” into a high value on a talkativeness dimension. The server represents feature data as a vector F of real-valued and categorical elements, where each element corresponds to an appearance or personality attribute. The server writes the resulting feature data into a feature table and maintains a many-to-one relationship between user identifiers and active feature data sets.

In one embodiment, the server transmits feature data to a generation processing apparatus to generate images or motion data for the virtual display object. The server constructs a prompt sentence suitable for an image generation model, such as:
“Generate a full-body illustration of a cute dog-like virtual character with big, expressive eyes and a bright blue collar, smiling and standing in a friendly pose, suitable for use as a health assistant avatar on a smartphone.”

The server encapsulates this prompt sentence and the numeric feature vector F in a request to the generation processing apparatus. The generation processing apparatus uses a generative AI model implemented as a deep neural network, such as a convolutional neural network with latent diffusion or generative adversarial network architecture. The model receives the prompt sentence as text tokens, encodes them into embeddings, and iteratively refines an image representation in a latent space by minimizing a loss function (for example, a denoising objective or adversarial loss). The generation processing apparatus outputs image data in a standard format such as a raster image or a sequence of frames. The server receives the image data, stores it in a media store, and records a reference to the stored image data in association with the feature data.

The server similarly requests motion data from the generation processing apparatus, where the generative AI model predicts animation parameters such as joint rotations and key frame sequences based on the feature data and a motion prompt sentence. The server can use a prompt sentence such as:
“Generate an idle animation for a very friendly, talkative dog-like avatar greeting the user with a gentle tail wag and a slight head tilt.”

The generation processing apparatus encodes this prompt sentence, uses a recurrent or transformer-based neural network operating on a time axis to output a sequence of pose vectors, and returns motion data that can be directly consumed by the user terminal rendering engine, such as a game engine.

In one embodiment, the user terminal executes a rendering application built on a three-dimensional rendering framework (for example, an engine comparable to Unity or Unreal Engine). The user terminal downloads image and motion data from the server and applies them to a scene graph representing the virtual display object. The user terminal maps feature data parameters to rendering shaders, animation state machines, and user interface elements so that the virtual display object visually reflects the appearance and personality attributes specified by the user via the prompt sentences.

In one embodiment, the server acquires multi-modal user data used to estimate an emotion state. The user terminal captures voice information through a microphone and image information through a camera directed at the user. The user terminal packages the audio and image data and transmits them to the server. The server uses a speech-to-text component, such as an automatic speech recognition model, to transform voice information into character information. The server then uses a sentiment analysis model, such as a transformer-based text classifier, to output sentiment scores (for example, probabilities for positive, neutral, negative). The server simultaneously uses an emotion estimation model, such as a convolutional neural network for facial expression recognition, to predict probabilities of basic emotions from image information.

The server aggregates these predictions in the emotion estimation module. The server constructs an emotion state vector E that includes, for each emotion category, a probability and, optionally, a temporal component representing the evolution of that emotion over time. The server may, for example, use a weighted average or a Kalman filter-like update to smooth emotion predictions across frames. By maintaining E as a time-dependent state variable in memory, the server reduces spurious fluctuations and improves the stability of avatar responses, thus improving the technical performance of the avatar system in terms of responsiveness and perceived smoothness.

In one embodiment, the server acquires biometric information and behavior information from sensors attached to the user or integrated into the user terminal. The user attaches a heart-rate sensor, a motion sensor, or a wearable device. The terminal reads heart-rate samples at regular intervals and stores timestamps, heart-rate values, and motion vectors in a local buffer. The terminal sends the buffered time-series data to the server as batched transmissions. The server stores the received data as time-series records in a biometric table, with indices by user identifier and timestamp. The server uses a time-series preprocessing module implemented with numerical libraries to perform smoothing (for example, moving average, low-pass filter), outlier removal (for example, threshold-based capping or median filtering), and resampling (for example, interpolation to fixed time intervals).

The server then generates feature quantity data from the time-series data. The server computes statistical features such as mean heart rate, variance, maximum sustained heart rate over a window, duration of low-movement intervals, and frequency-domain characteristics (for example, power in certain frequency bands obtained by a fast Fourier transform). The server combines these features into a feature quantity vector H. The server then feeds H into a health and behavior evaluation model. The model may be realized as a neural network with fully connected layers, or as a gradient-boosted decision tree. The model outputs estimates of health state (for example, normal, elevated load, fatigue risk) and behavior state (for example, prolonged static posture, low activity, high activity).

The server stores the health state and behavior state as discrete labels and as continuous scores. Because the server computes these states on structured feature quantity data and uses model parameters trained from previously collected labeled data, the server can more accurately identify conditions, such as elevated cardiovascular strain or work overload, compared to simpler rule-based systems. This improves the precision and recall of state estimation, which in turn allows the system to target support content more accurately and avoid unnecessary or inappropriate interruptions. This is a technical improvement in the operation of the computer system, as it optimizes when and how processing resources are used to generate and transmit support messages.

In one embodiment, the server constructs prompt sentences to drive generative AI models in a structured way. The server does not simply pass raw user text to the generative AI model. Instead, the server uses the prompt construction module to generate composite prompt sentences that encode the current emotion state E, the health and behavior states H, the feature data F, and contextual metadata such as time of day and usage history. For example, when the user is detected as sad with high intensity and the health evaluation indicates sleep deficit, the server constructs a prompt sentence such as:
“The user's message is: ‘I feel a bit tired and sad today.’ The detected emotion is sadness with high intensity. The user has averaged only 5 hours of sleep per night during the last 7 days. You are a gentle, dog-like virtual companion who speaks in a warm and supportive tone. Generate a short, empathetic reply that comforts the user and suggests one or two simple changes to improve sleep habits.”

The server passes this structured prompt sentence to a generative AI model implemented as a transformer-based neural network with multiple attention layers and feed-forward layers. The model has been trained on large-scale text data to minimize a cross-entropy loss with respect to next-token prediction. During operation, the server applies a decoding algorithm (for example, beam search or nucleus sampling) with bounded parameters (for example, maximum length, temperature, top-k or top-p values) controlled by the generative AI interface module. The server receives the generated response message and can also interpret certain tokens or markers (for example, tags indicating “comforting tone” or “include suggestion”) as response action information controlling the virtual display object's behavior.

By structuring prompt sentences in this way, the server uses the generative AI model as a controllable component rather than as a generic text generator. This approach reduces variance in responses, improves reproducibility of behaviors, and simplifies testing, because the server can verify that certain constructs in the prompt sentence map to expected types of outputs. This improves the internal data flow and reduces the need for post-hoc rule-based corrections, thereby improving processing efficiency and reliability. The use of structured prompt sentences as internal control artifacts is a non-traditional implementation technique that reconfigures the way the computer system orchestrates language models, and it is not merely a straightforward automation of human conversation.

In one embodiment, the server constructs prompt sentences for various types of support content. For a break proposal based on elevated heart rate and prolonged sitting, the server may generate the prompt sentence:
“The worker's heart rate has been higher than usual for the last 10 minutes and the worker has been sitting continuously. Generate a short, friendly notification asking the worker to take a 5-minute break and drink some water.”

For a product proposal in a store context, the server may generate:
“The user in a virtual store appears stressed while browsing lifestyle products. You are a polite, helpful virtual clerk. Suggest one or two relaxing products such as aroma candles or herbal teas, and explain briefly how they can help the user feel more relaxed.”

For an avatar customization operation, the server may use:
“Create a detailed profile for a virtual avatar that looks like a dog and has a very talkative and friendly personality. Describe its visual appearance (fur color, clothing, facial expression style), its typical way of speaking, and one short sample self-introduction.”

By using different prompt templates and injecting structured state information, the server can reuse a single generative AI model for multiple distinct functions (dialogue, avatar profile generation, support messages) without duplicating logic, which reduces resource consumption and improves maintainability of the system.

In one embodiment, the server implements a generative AI model interface module that maintains persistent connections to one or more model servers, caches frequently used embeddings, and batches multiple prompt sentence requests where possible. By batching and caching, the server reduces network overhead and amortizes computation across multiple users. The server can also pre-compute and store partial prompt embeddings corresponding to static parts of prompts (for example, avatar personality description) so that only dynamic segments (for example, current emotion tags and health states) require new computation. This reduces response latency and improves throughput, which is a technical enhancement of the computer system's performance.

In one embodiment, the user terminal renders the virtual display object and presents generated messages in a synchronized manner. When the server sends response messages and response action information, the user terminal parses the response action information, updates animation state machines, and triggers specific motion patterns, facial expressions, and utterance content. For example, when the server indicates that a comforting response should be displayed, the user terminal selects an animation pattern with a soft facial expression and slow gestures. The user terminal uses a text-to-speech engine to read the response message aloud, aligning phonemes with lip motion parameters if available. This coordinated control of visual and auditory outputs transforms abstract responses into concrete, temporally aligned signals that act on display and audio hardware, thereby effecting a technical transformation of electrical signals into user-perceivable stimuli.

In one embodiment, the server dynamically adjusts behavior of the virtual display object based on ongoing emotion and health tracking. When the emotion state indicates repeated sadness or stress over several days, and when the health state indicates chronic sleep deficit or low activity, the server increases the frequency and specificity of lifestyle improvement proposals. For example, the server may generate prompt sentences that emphasize sleep hygiene or moderate exercise frequency. By integrating multiple state signals, the server can reduce the amount of indiscriminate output and focus computational resources on contexts where intervention is more likely to be beneficial, reducing unnecessary communication load between server and user terminal and thereby improving network efficiency.

In one embodiment, the server uses a multi-task learning neural network architecture for health and emotion estimation, where shared layers process common low-level features and task-specific heads output health state and emotion state. The shared layers may include fully connected layers with non-linear activation functions, batch normalization, and dropout for regularization. The server trains this network using supervised learning on labeled datasets containing pairs of time-series data and labels for health and emotion states. The server uses a combined loss function, such as a weighted sum of cross-entropy losses for each task. During training, the server applies stochastic gradient descent or an adaptive optimizer to adjust weights, and may use data augmentation techniques such as adding noise or time-warping to improve generalization. This architecture allows the server to share representations between tasks, which improves estimation accuracy and reduces model size and inference time compared to training separate models, thus providing a concrete computational benefit.

In another embodiment, the server uses a rule-based layer on top of neural network outputs. The rule-based layer interprets model scores according to safety thresholds and context conditions. For example, the server may suppress certain types of notifications late at night, or may require multiple consecutive high-risk readings before triggering a break proposal. These machine-implemented rules differ from human decision-making because they operate on high-dimensional model outputs and time-series aggregates in real time and are executed deterministically according to programmable conditions. The combination of learned models and explicit rules reduces false positives and prevents excessive or inappropriate triggers, improving the robustness of the automated system.

In one alternative embodiment, the server integrates additional sensors, such as skin temperature sensors or galvanic skin response sensors, into the time-series data pipeline. The server extends the feature extraction module to compute additional features, such as temperature variations or skin conductance changes, and retrains the health state model to account for these new inputs. This extensible data structure and model architecture allows the system to incorporate new modalities without redesigning the entire pipeline, which is a practical technical advantage.

In another alternative embodiment, the generative AI model is hosted locally on the same machine as the server, and the server uses a model quantization technique to reduce memory footprint and increase inference speed. The server performs quantization-aware training or post-training quantization to reduce weight precision from floating point to fixed-point representations. This reduces memory bandwidth and improves inference latency on CPUs without dedicated accelerators. In yet another embodiment, the server deploys separate generative AI models for different functions (for example, one for dialogue, one for avatar description, one for motion hint generation) and selects among them by analyzing prompt type and context.

The server, in all embodiments, uses prompt sentences not as mere user-facing natural language but as internal control sequences that encode state vectors, configuration parameters, and intended outcomes in a unified text representation. By doing so, the server aligns the internal data representation with the input interface of transformer-based generative models, reducing the need for non-linear bridging logic and enabling more direct, efficient integration between state estimation components and generative components. This integration yields measurable improvements in processing speed, resource usage, and output coherence, and represents a specific implementation of computer technology that goes beyond abstract mental processes or generic business rules.

The user, in each embodiment, interacts with the system by providing prompt sentences, by speaking to the virtual display object, by wearing sensors that supply biometric and behavior information, and by observing and responding to the avatar's messages and actions on the user terminal. Through this interaction, the system closes a loop in which computational estimations of emotion and health are used to drive generative models and rendering hardware, and sensor data are continually fed back to refine those estimations, thereby forming a technically grounded control cycle that improves the behavior of the underlying computer system.

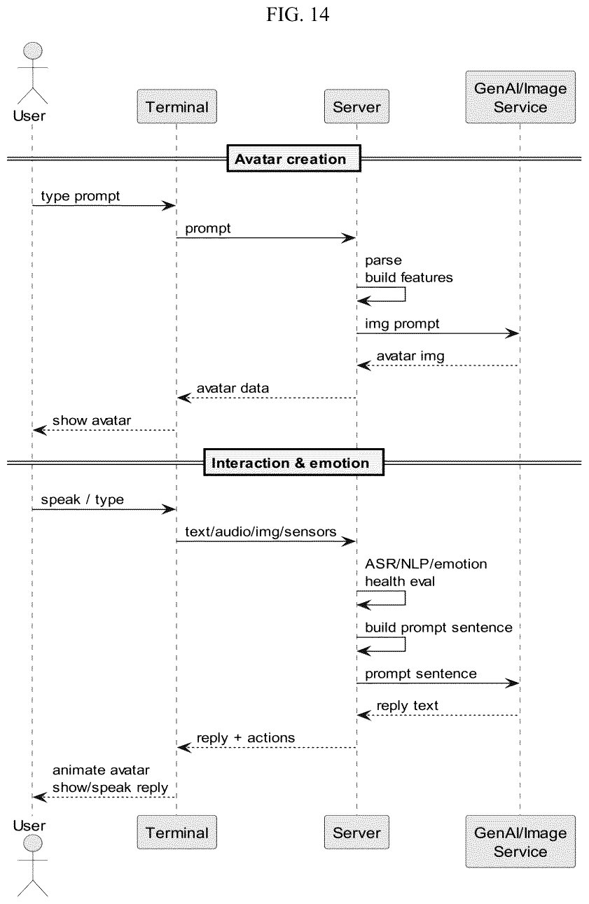

The following describes the processing flow using FIG. 14.

### Step 1

User inputs a prompt sentence describing a desired virtual display object.
User types, for example, “I like dogs. Please create a dog-like avatar that talks a lot and is very friendly.” into a text field on the terminal or speaks an equivalent utterance that the terminal transcribes into text.
Input: raw user text (prompt sentence).
Output: prompt sentence transmitted from the terminal to the server over a network connection.

### Step 2

Terminal transmits the prompt sentence to the server.
Terminal packages the prompt sentence together with a user identifier and a timestamp into a structured message, and sends the message to the server via a secure protocol such as HTTPS.
Input: raw prompt sentence and user metadata.
Output: structured request message delivered to the server's application interface.

### Step 3

Server parses the prompt sentence and generates intermediate semantic data.
Server receives the structured request, tokenizes the prompt sentence, and applies a natural language processing technique to identify parts of speech and dependency relations. Server then extracts candidate attributes such as “dog-like,” “talks a lot,” and “very friendly” and maps them to generic categories: appearance attributes and personality attributes.
Input: prompt sentence text and user metadata.
Data processing: tokenization, syntactic parsing, and semantic extraction.
Output: a semantic representation including attribute-value pairs for appearance and personality.

### Step 4

Server converts the semantic representation into feature data.
Server maps symbolic attributes into a normalized feature vector F and/or structured feature object. For example, server encodes “dog-like” as a categorical index, “talks a lot” as a high value on a talkativeness dimension, and “very friendly” as a high value on a friendliness dimension. Server stores F in a feature data store associated with the user.
Input: semantic attribute-value pairs.
Data processing: attribute-to-parameter mapping, normalization, and vector construction.
Output: feature data representing the virtual display object's appearance and personality.

### Step 5

Server constructs an image-generation prompt sentence and requests visual data.
Server uses feature data F to build a descriptive prompt sentence such as “Generate a full-body illustration of a cute dog-like virtual character with big, expressive eyes and a bright blue collar, smiling and standing in a friendly pose, suitable for use as a health assistant avatar on a smartphone.” Server sends this prompt sentence, together with feature parameters, to a generation processing apparatus that hosts an image-oriented generative AI model.
Input: feature data F.
Data processing: template filling and text composition to create a detailed image-generation prompt sentence.
Output: image-generation prompt sentence and associated parameters transmitted to the generation processing apparatus.

### Step 6

Server receives image data and motion data from the generation processing apparatus.
Server obtains rendered image data (for example, a raster image) and optionally motion data (for example, a sequence of body poses) generated by the generative AI model according to the prompt sentence. Server stores both in media storage and registers references linked to the feature data and user identifier.
Input: generated image data and motion data from the generation processing apparatus.
Data processing: validation, metadata attachment, and storage indexing.
Output: stored media resources and corresponding database records.

### Step 7

### Server Transmits Avatar Data to the Terminal.

Server composes a response message containing image URLs or binary data, motion parameters, and feature data summary, and sends this message to the terminal.
Input: stored media references and feature data.
Data processing: packaging into a structured response format.
Output: avatar configuration data delivered to the terminal.

### Step 8

Terminal renders the virtual display object.
Terminal downloads the image data and motion data if necessary, loads them into a rendering engine, and binds them to a model or sprite on the display. Terminal configures animation state machines according to the received motion parameters and personality attributes (for example, selecting an idle animation with gentle tail wagging).
Input: avatar image data, motion data, and feature data.
Data processing: resource loading, scene graph configuration, and animation setup.
Output: visual and animated representation of the virtual display object on the terminal display.

### Step 9

User interacts with the rendered virtual display object.
User observes the avatar on the display, may speak to the avatar, may type additional prompt sentences such as “Change the eye color to green and make the character more energetic,” and may perform gestures or other interactions.
Input: current avatar display and user's intentions.
Output: new user input (voice, text, or actions) captured by the terminal.

### Step 10

Terminal captures user voice and image information for emotion estimation.
Terminal records microphone audio while the user speaks and captures camera frames of the user's face. Terminal associates these with timestamps and the current interaction context and transmits them to the server.
Input: raw audio signals and camera images.
Data processing: local buffering, compression, and metadata tagging.
Output: multi-modal user data sent to the server.

### Step 11

Server converts voice information to character information.
Server supplies the received audio to a speech recognition component, obtains a text transcript, and cleans the text (for example, removing filler words and normalizing capitalization). Server stores the transcript in conversation logs.
Input: raw audio data.
Data processing: acoustic feature extraction, decoding, and text normalization.
Output: character information (recognized user utterance text).

### Step 12

Server estimates the emotion state from multi-modal data.
Server analyzes the character information using a sentiment classifier to obtain polarity and intensity scores. Server analyzes the image information using an emotion recognition model to obtain probabilities for emotion categories such as joy, sadness, and stress. Server fuses these signals into an emotion state vector E by combining probabilities and smoothing over time.
Input: character information and image information.
Data processing: sentiment classification, emotion classification, temporal smoothing, and state vector composition.
Output: emotion state E indicating the user's current emotional condition.

### Step 13

Server evaluates the health state and behavior state from biometric and behavior information.
Server retrieves newly received time-series sensor data (heart rate, motion, etc.) and applies filters to remove noise and resample values. Server computes feature quantity data H (for example, mean heart rate, standard deviation, sedentary duration) and passes H through a trained evaluation model. The model outputs labels and scores for health state (for example, normal or elevated load) and behavior state (for example, prolonged sitting).
Input: raw time-series biometric and behavior data.
Data processing: smoothing, feature extraction, and model-based classification/regression.
Output: evaluated health state and behavior state, represented as scores and labels.

### Step 14

Server constructs a response prompt sentence for conversational output.
Server retrieves feature data F, emotion state E, and health/behavior states, as well as the latest user text or recognized utterance. Server builds a composite prompt sentence such as “The user's message is: ‘I feel a bit tired and sad today.’ The detected emotion is sadness with high intensity. The user has averaged only 5 hours of sleep per night during the last 7 days. You are a gentle, dog-like virtual companion who speaks in a warm and supportive tone. Generate a short, empathetic reply that comforts the user and suggests one or two simple changes to improve sleep habits.”
Input: feature data F, emotion state E, health/behavior evaluation, and user utterance.
Data processing: template selection, slot filling, and concatenation into a single control-oriented prompt sentence.
Output: response-generation prompt sentence.

### Step 15

Server generates a response message using a generative AI model.
Server submits the response-generation prompt sentence to a text-oriented generative AI model, specifies decoding parameters, and receives a natural-language response. The response may include suggestions such as “If you can, try going to bed just 30 minutes earlier and keeping your room darker and quieter.” Server optionally post-processes the response to enforce safety and length constraints.
Input: response-generation prompt sentence.
Data processing: token encoding, neural network inference, decoding, and optional post-processing.
Output: response message text and optional metadata (for example, tone tags).

### Step 16

Server constructs support content when required.
Server evaluates whether the health state, behavior state, and emotion state satisfy conditions for generating support content such as break proposals, exercise proposals, lifestyle improvement proposals, or product proposals. If so, server creates a dedicated support prompt sentence, for example: “The worker's heart rate has been higher than usual for the last 10 minutes and the worker has been sitting continuously. Generate a short, friendly notification asking the worker to take a 5-minute break and drink some water.” Server sends this prompt sentence to the generative AI model and receives a support message.
Input: evaluation results (health and behavior) and emotion state.
Data processing: rule evaluation, support type selection, prompt sentence formulation, and generative inference.
Output: support message text associated with a support category.

### Step 17

Server aggregates response messages and support messages into a presentation package.
Server combines conversational response messages, support messages, and associated action directives (for example, “comfort,” “encourage exercise,” “recommend product”) into a single package. Server converts action directives into high-level avatar behavior codes (for example, “smile_slow,” “gesture_point,” “head_tilt”) to be interpreted by the terminal.
Input: response message text, support message text, emotion tags, and state evaluations.
Data processing: message prioritization, packaging, and behavior code assignment.
Output: presentation package containing text messages and avatar action codes.

### Step 18

Server transmits the presentation package to the terminal.
Server sends the package via a pushed notification or a persistent communication channel. The package includes message texts, action codes, and any timing or priority information.
Input: presentation package.
Data processing: serialization and transmission over the network.
Output: received package at the terminal side.

### Step 19

Terminal interprets avatar action codes and messages.
Terminal decodes the presentation package, maps action codes to specific animations, facial expressions, and voice parameters, and prepares display and audio buffers. For example, terminal selects a “soft smile” facial animation, a “slow wave” hand gesture, and a calm text-to-speech voice.
Input: presentation package from the server.
Data processing: code-to-animation mapping, text-to-speech preparation, and UI layout planning.
Output: configured visual and audio instructions ready for rendering.

### Step 20

Terminal presents the messages and avatar behaviors to the user.
Terminal updates the virtual display object on the screen, plays the selected animations, and outputs synthesized speech containing the response message and any support message. Terminal displays the text messages in overlays or dialogue bubbles synchronized with the avatar motions.
Input: configured visual and audio instructions.
Data processing: rendering, audio playback, and synchronization.
Output: perceptible feedback to the user in the form of on-screen animation and sound.

### Step 21

User responds to the avatar's output and optionally adjusts preferences.
User may accept proposals, decline them, request more information, or issue new customization prompt sentences such as “Change the eye color to green and make the character more energetic.” User may also modify settings to influence frequency of support messages.
Input: displayed avatar behavior and messages.
Output: new interactions provided by the user (prompt sentences, selections, or settings changes).

### Step 22

Terminal records user responses and sends them to the server.
Terminal captures user selections (for example, “Start break,” “Skip suggestion,” “Show product details”), interaction timing, and any new prompt sentences, and forwards this information to the server.
Input: user selections and new prompt sentences.
Data processing: logging, formatting, and secure transmission.
Output: interaction data delivered to the server for further processing and model adaptation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

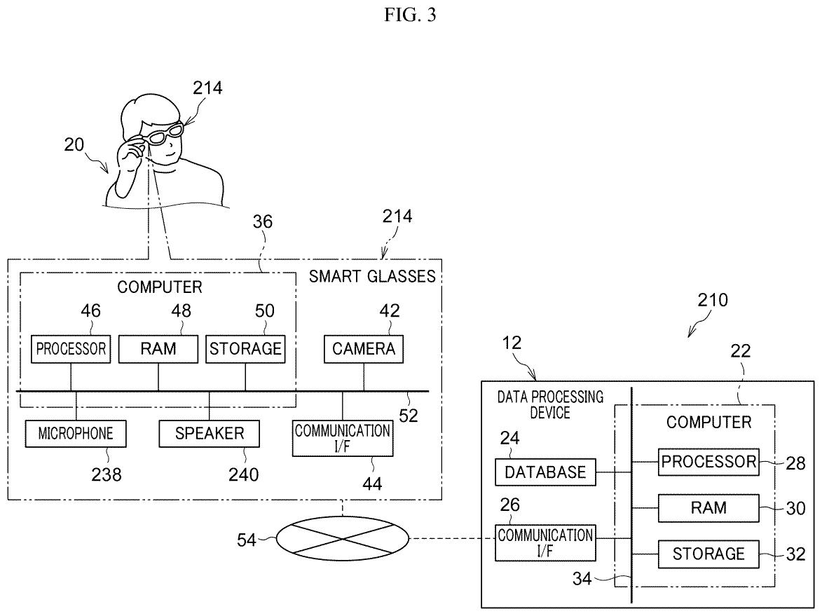

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

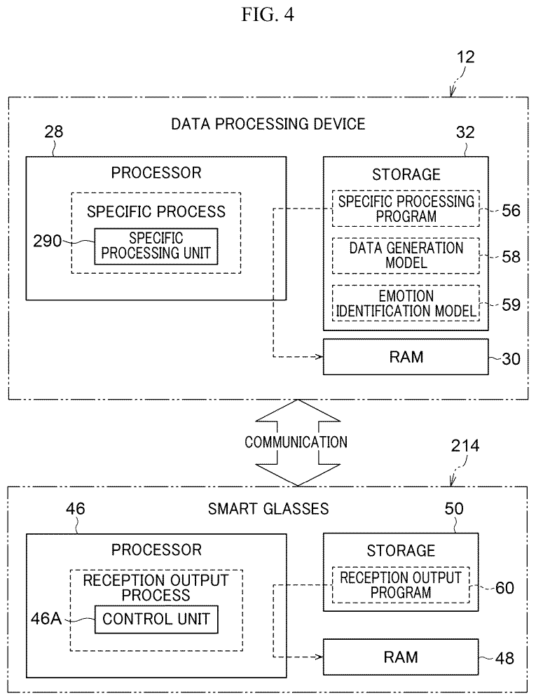

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

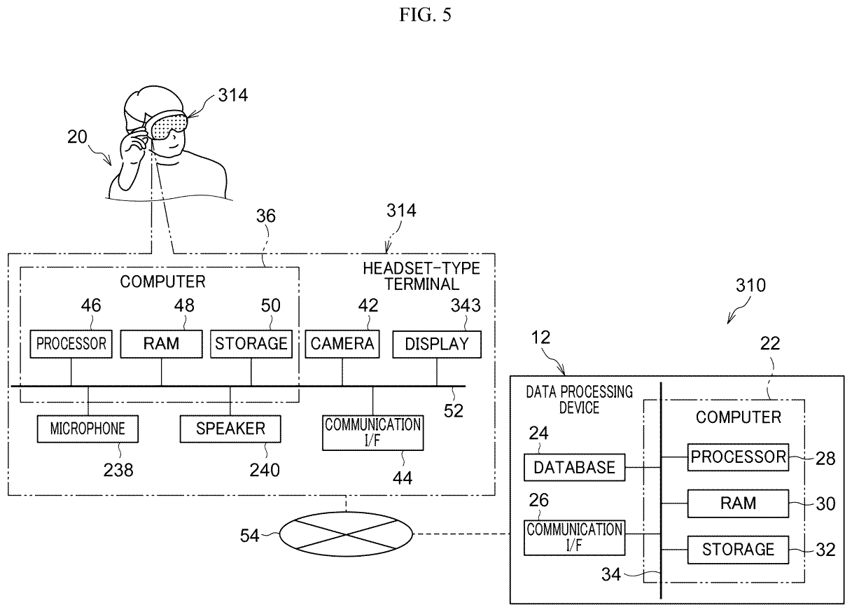

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

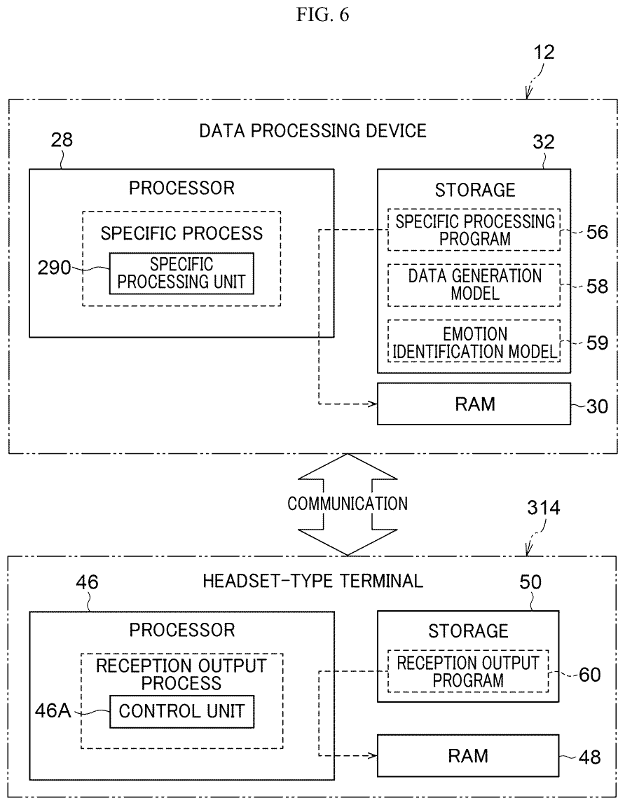

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

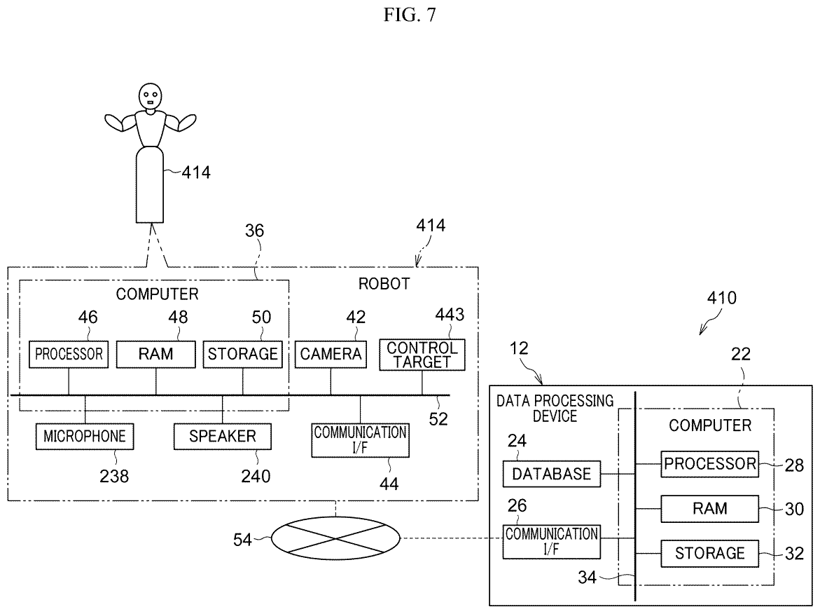

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

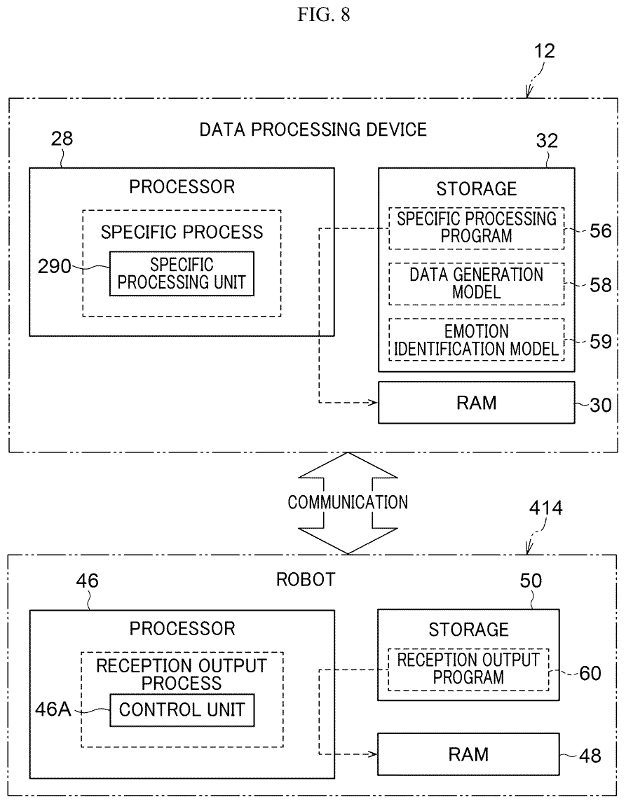

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

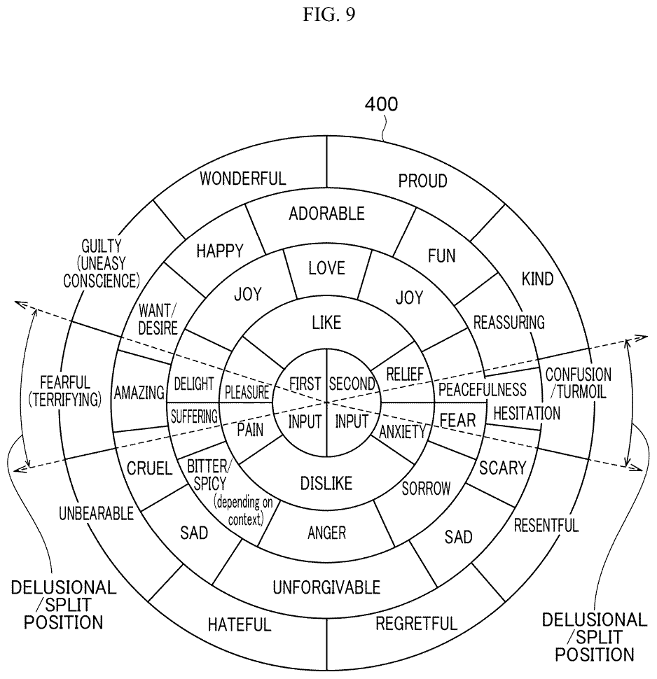

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

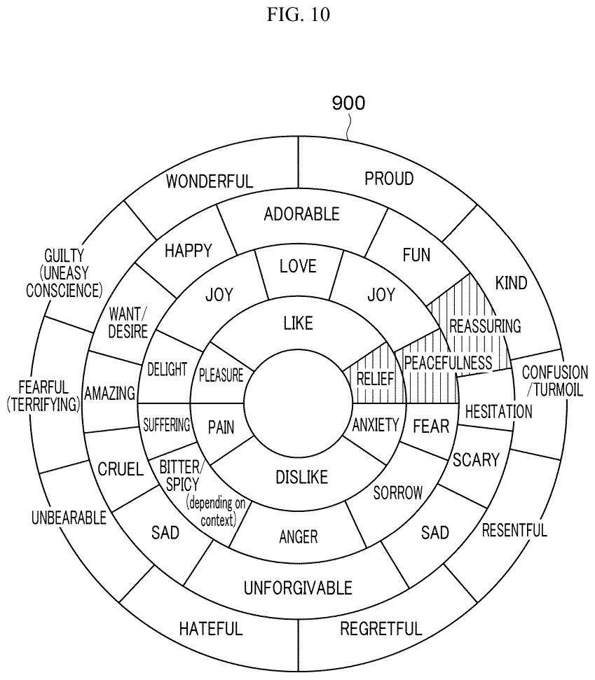

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a user terminal, input information including a prompt sentence, and analyze the prompt sentence by natural language processing to extract attribute information representing preferences of a user,
generate, based on the attribute information and the prompt sentence, a prompt sentence for instructing a generative artificial intelligence model to determine appearance, personality, and behavior patterns of an avatar, and execute the generative artificial intelligence model on a computing device to generate structured data including feature data of the avatar,
create, based on the structured data, an image-generation prompt sentence for generating a visual representation of the avatar, generate image data of the avatar by using a generative image model, and transmit the feature data and the image data to the user terminal so that the avatar is visually displayable on the user terminal,
receive, via the user terminal, a dialogue message transmitted from the user to the avatar,
generate, based on the dialogue message and the feature data, a conversation-generation prompt sentence, and generate a response message of the avatar by using the generative artificial intelligence model, and
estimate an emotional state of the user based on contents of the dialogue message and the response message, update at least a part of the feature data and the conversation-generation prompt sentence in accordance with the estimated emotional state, and dynamically adjust reaction characteristics of the avatar for each dialogue through transmission of updated information to the user terminal.

### Supplementary 2

The system according to supplementary 1,
wherein the processor is configured to
generate, as the prompt sentence to be input to the generative artificial intelligence model, structured data in a machine-readable format including attribute information relating to the appearance and the personality of the avatar, manage the appearance, the personality, and the behavior patterns of the avatar as a plurality of separate parameters in accordance with the structured data, and individually change each of the parameters in response to a new prompt sentence received from the user.

### Supplementary 3

The system according to supplementary 1,
wherein the processor is configured to
record, as history information, a plurality of dialogue message sequences transmitted and received with the user terminal, provide the history information as additional input to the generative artificial intelligence model to continuously adapt a response style and reaction patterns of the avatar to each user, and generate the response of the avatar so as to reduce loneliness of the user through interactions adapted to the emotional state of the user.

### Application Example 1

### Supplementary 1

A system comprising a processor,
wherein the processor is configured to
acquire user behavior history information and preference information, and generate user attribute information indicating user interests based on the behavior history information and the preference information,
generate a prompt sentence for input to a generative information processing model based on the user attribute information, and input the prompt sentence to the generative information processing model to generate feature information including avatar appearance information and avatar personality information,
generate visual representation data of an avatar based on the feature information, transmit the visual representation data and the avatar personality information to a terminal device, and cause the terminal device to visually display the avatar in a virtual space,
search product information stored in a product information storage device based on the user attribute information and input information from a user, and generate recommendation product information by extracting products suitable for the user,
generate a response prompt sentence for input to the generative information processing model based on the recommendation product information and the avatar personality information, input the response prompt sentence to the generative information processing model, and
generate dialogue information representing product introduction and dialogue responses by the avatar,
transmit the dialogue information to the terminal device and cause the terminal device to present the recommendation product information via the avatar, collect dialogue history information between the avatar and the user and operation history
information of the user with respect to the recommendation product information, and generate learning information for updating the user attribute information and the recommendation product information, and
update generation processing of the user attribute information and the recommendation product information based on the learning information, and dynamically optimize the avatar appearance information, the avatar personality information, and the dialogue information.

### Supplementary 2

The system according to supplementary 1,
wherein the processor is configured to use, as the generative information processing model, an information processing model using natural language processing technology, and to analyze the prompt sentence and the response prompt sentence so as to change the avatar appearance information and the avatar personality information and to generate dialogue information according to the user attribute information and the recommendation product information.

### Supplementary 3

The system according to supplementary 1,
wherein the processor is configured to estimate an emotional state of the user based on the input information acquired from the user and the dialogue history information, to modify the response prompt sentence according to the emotional state, and to generate the dialogue information so as to improve a psychological state of the user through dialogue via the avatar.

### Example 2

### Supplementary 1

A system comprising a processor,
wherein the processor is configured to
parse a natural language prompt sentence acquired from a user, and generate feature information by generating, based on the prompt sentence, a prompt sentence for input to a generative information processing model,
generate display control information relating to an appearance and a personality of a visual representation entity based on the feature information, and transmit the display control information to a terminal device so as to cause the terminal device to display the visual representation entity,
acquire biometric measurement information and behavior information of the user via a body information acquisition apparatus and the terminal device, and store the biometric measurement information and the behavior information,
execute information processing on the stored biometric measurement information and behavior information to calculate a health state index and an activity index of the user, and generate analysis result information,
generate, based on the analysis result information and the natural language prompt sentence acquired from the user, a health management and daily living behavior prompt sentence for input to the generative information processing model, and cause the generative information processing model to generate advice information,
generate response expression information of the visual representation entity according to a health state and an emotional state of the user based on the advice information, and notify the user via the terminal device,
store schedule information and behavior goal information acquired from the user, generate notification information based on the schedule information and the behavior goal information, and cause the terminal device to execute reminder notification based on the notification information, and
acquire evaluation information or response information from the user regarding the advice information and the notification information, and update the prompt sentence for input to the generative information processing model and operation conditions of the generative information processing model based on the evaluation information or the response information.

### Supplementary 2

The system according to supplementary 1,
wherein the processor is configured to
include, in the prompt sentence for input to the generative information processing model, attribute information representing the health state index, the activity index, the schedule information, and the behavior goal information of the user, and instruction information relating to an expression style, a length, and content constraints of the advice information, so as to cause the generative information processing model to generate health management advice and daily living behavior advice that are individualized for each user.

### Supplementary 3

The system according to supplementary 1,
wherein the processor is configured to
aggregate evaluation information and response information collected from a plurality of users to generate statistical information, and adjust configuration elements of the prompt sentence and training data or weight parameters of the generative information processing model based on the statistical information, so as to improve suitability of the advice information and the response expression information of the visual representation entity that are generated in the future.

### Application Example 2

### Supplementary 1

A system comprising a processor,
wherein the processor is configured to
parse a prompt sentence received from a user, generate instruction information for determining an appearance attribute and a personality attribute of a virtual display object, generate a further prompt sentence including the instruction information, and generate feature data for the virtual display object on the basis of the further prompt sentence,
output control information including a prompt sentence for causing a generation processing apparatus to perform image generation or motion control of the virtual display object on the basis of the feature data, receive image data or motion data generated by the generation processing apparatus, and transmit the image data or the motion data to a user terminal so that the user terminal visually displays the virtual display object,
analyze voice information, image information, or character information acquired from the user, and estimate an emotion state of the user,
construct a prompt sentence for generating a response content or a response action of the virtual display object on the basis of the estimated emotion state and the feature data, input the prompt sentence to a generative AI model, generate a response message or response action information of the virtual display object by using the generative AI model, and transmit a result of the generation to the user terminal,
store biometric information or behavior information acquired from the user as time-series data, preprocess the time-series data to generate feature quantity data, and evaluate a health state or a behavior state of the user on the basis of the feature quantity data, and
construct a prompt sentence for generating support content including at least one of a break proposal, an exercise proposal, a lifestyle improvement proposal, and a product proposal, on the basis of an evaluation result of the health state or the behavior state and the emotion state, input the prompt sentence to the generative AI model to generate a support message, and present the support message to the user via the virtual display object.

### Supplementary 2

The system according to supplementary 1,
wherein the processor is configured to
analyze the prompt sentence input by the user by using a natural language processing technique, extract instruction content relating to initial setting or change setting of the appearance attribute or the personality attribute of the virtual display object, and update the feature data in accordance with the instruction content.

### Supplementary 3

The system according to supplementary 1,
wherein the processor is configured to
dynamically control at least one of utterance content, facial expression, posture, and motion pattern of the virtual display object on the basis of at least one of the emotion state, the health state, and lifestyle information of the user, and cause the generative AI model to generate a dialogue sentence suitable for at least one of emotion alleviation, motivation, and purchase support, thereby performing psychological support and behavior support for the user through interaction with the user.

What is claimed is:

1. A system comprising:
circuitry configured to:
receive, via a communication interface coupled to a packet-switched network, input data comprising a natural-language sentence from a terminal device;
analyze the input data using natural language processing to extract attribute information representing user preferences;
generate instruction data based on the attribute information and transmit the instruction data to a generative model to cause the generative model to output feature data defining appearance parameters and behavioral parameters of a visual entity;
generate visual representation data based on the feature data and transmit the visual representation data to the terminal device via the communication interface to cause the terminal device to render the visual entity on a display unit; and
estimate an affective state of the user based on dialogue data received from the terminal device and adjust the behavioral parameters of the visual entity in accordance with the estimated affective state.

2. The system according to claim 1, wherein the circuitry is configured to:
generate an image-generation instruction based on the feature data, and
transmit the image-generation instruction to a generative image model to produce image data of the visual entity.

3. The system according to claim 1, wherein the circuitry is configured to:
receive a dialogue message from the terminal device directed to the visual entity,
generate a conversation-generation instruction based on the dialogue message and the feature data, and
transmit the conversation-generation instruction to the generative model to obtain a response message.

4. The system according to claim 3, wherein the circuitry is configured to:
update at least a part of the feature data and the conversation-generation instruction in accordance with the estimated affective state, and
transmit updated response characteristics to the terminal device for each dialogue interaction.

5. The system according to claim 1, wherein the feature data comprises structured data in a machine-readable format, and the circuitry is configured to:
manage the appearance parameters and the behavioral parameters as a plurality of separate parameter fields within the structured data, and
individually modify each parameter field in response to a subsequent input data received from the terminal device.

6. The system according to claim 1, wherein the circuitry is configured to:
record dialogue message sequences exchanged with the terminal device as history data in a storage device, and
provide the history data as additional input to the generative model to continuously adapt a response style of the visual entity to the user.

7. The system according to claim 1, wherein the circuitry is configured to:
acquire user behavior history data and preference data from the storage device,
generate user attribute information indicating user interests based on the behavior history data and the preference data, and
generate the instruction data based on the user attribute information.

8. The system according to claim 7, wherein the circuitry is configured to:
search item information stored in an item information storage device based on the user attribute information, and
generate recommendation data by extracting items corresponding to the user attribute information.

9. The system according to claim 8, wherein the circuitry is configured to:
generate a response instruction based on the recommendation data and the behavioral parameters, and
transmit the response instruction to the generative model to generate dialogue data presenting the recommendation data via the visual entity.

10. The system according to claim 9, wherein the circuitry is configured to:
collect dialogue history data and user operation history data with respect to the recommendation data, and
generate learning data for updating the user attribute information and the recommendation data based on the collected data.

11. The system according to claim 1, wherein the circuitry is configured to:
estimate the affective state based on at least one of text content of the dialogue data, audio characteristics of the dialogue data, or image data received from the terminal device.

12. The system according to claim 1, wherein the generative model comprises a transformer-based language model, and the circuitry is configured to:
tokenize the instruction data into token sequences, and
transmit the token sequences to the transformer-based language model via the communication interface.

13. The system according to claim 1, wherein the circuitry is configured to:
render the visual entity within a virtual space on the terminal device, and
control positioning and animation of the visual entity within the virtual space based on the feature data.

14. The system according to claim 1, wherein the circuitry is configured to:
generate a summary of the dialogue history and the affective state transitions, and
transmit the summary to a monitoring terminal device via the communication interface.

15. The system according to claim 1, wherein the circuitry is configured to:
dynamically optimize the appearance parameters, the behavioral parameters, and the response style of the visual entity based on accumulated interaction data.

16. The system according to claim 1, wherein the terminal device comprises at least one of a mobile computing device, a wearable display device, a headset-type terminal, or a robotic apparatus, each coupled to the packet-switched network via the communication interface.

17. The system according to claim 16, wherein the terminal device comprises the wearable display device including a microphone and a speaker, and the circuitry is configured to:
receive audio data representing user speech from the wearable display device, and
transmit audio output data to the speaker of the wearable display device based on the response message.

18. The system according to claim 1, wherein:
the circuitry comprises a processor, a memory storing a program, a communication interface, and a storage device,
the processor executes the program to implement the natural language processing and the generation of the feature data,
the storage device stores the feature data, the dialogue data, and the history data, and
the communication interface exchanges data with the terminal device over the packet-switched network.

19. The system according to claim 18, wherein the storage device comprises a user profile database that associates user identifiers with attribute information, preference data, and affective state records.

20. A method performed by circuitry, the method comprising:
receiving, via a communication interface coupled to a packet-switched network, input data comprising a natural-language sentence from a terminal device;
analyzing the input data using natural language processing to extract attribute information representing user preferences;
generating instruction data based on the attribute information and transmitting the instruction data to a generative model to cause the generative model to output feature data defining appearance parameters and behavioral parameters of a visual entity;
generating visual representation data based on the feature data and transmitting the visual representation data to the terminal device via the communication interface to cause the terminal device to render the visual entity on a display unit; and
estimating an affective state of the user based on dialogue data received from the terminal device and adjusting the behavioral parameters of the visual entity in accordance with the estimated affective state.
